(19) United States
(12) Patent Application Publication
(10) Pub. No.: US 2025/0363274 A1
(43) Pub. Date: Nov. 27, 2025

(54) INTEGRATED CIRCUIT DESIGN SYSTEM, METHOD AND COMPUTER PROGRAM PRODUCT

(71) Applicant: TAIWAN SEMICONDUCTOR MANUFACTURING COMPANY, LTD., Hsinchu (TW)

(72) Inventors: Ritvik RATHORE, Hsinchu (TW); Yu-Ze LIN, Hsinchu (TW); Yu-Hao LIU, Hsinchu (TW); King-Ho TAM, Hsinchu (TW)

(21) Appl. No.: 19/292,292

(22) Filed: Aug. 6, 2025

Related U.S. Application Data
(63) Continuation of application No. 18/886,448, filed on Sep. 16, 2024.
(60) Provisional application No. 63/620,320, filed on Jan. 12, 2024.

(51) Int. Cl. G06F 30/32; H02M 3/158

(52) U.S. Cl. CPC G06F 30/32; H02M 3/158

(57) ABSTRACT

A method is performed at least partially by a processor and includes, based on design specifications of a voltage regulator, determining parameters of the voltage regulator. The method further includes, based on the parameters of the voltage regulator, determining model parameters of a voltage regulator (VR) model of the voltage regulator. The method further includes performing a simulation of the voltage regulator, using the model parameters of the VR model. The VR model includes a voltage source coupled between an input and an output, and a compensation network of capacitors and resistors. The compensation network is coupled between the output and a first node. The model parameters of the VR model include a voltage value of the voltage source which corresponds to a voltage value at the first node.

### RELATED APPLICATION(S)

This application is a continuation application of U.S. patent application Ser. No. 18/886,448, filed Sep. 16, 2024, which claims the benefit of U.S. Provisional Application No. 63/620,320, filed Jan. 12, 2024. The above-referenced applications are herein incorporated by reference in their entireties.

### BACKGROUND

An integrated circuit (IC) device typically includes a number of semiconductor devices represented in an IC layout (or IC layout diagram). The IC layout is generated from an IC schematic, such as an electrical diagram of the IC device. At various steps during the IC design process, from the IC schematic to the IC layout for actual manufacture of IC devices, various checking and testing are performed to make sure that IC devices corresponding to the IC layout can be made and will function as designed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional flow chart of at least a portion of an IC design and fabrication process, in accordance with some embodiments.

FIGS. 2A-2B are schematic cross-sectional views of various semiconductor devices, in accordance with some embodiments.

FIGS. 2C-2D are block diagrams of various power delivery systems including voltage regulators for one or more IC devices, in accordance with some embodiments.

FIG. 2E includes Bode plots of various components in a voltage regulator, in accordance with some embodiments.

FIG. 3A is a circuit diagram of a voltage regulator, in accordance with some embodiments.

FIG. 3B is a circuit diagram of a multi-phase voltage regulator, in accordance with some embodiments.

FIG. 4 is a flowchart of a process of configuring, modeling and verifying a voltage regulator, in accordance with some embodiments.

FIGS. 5A-5B are circuit diagrams of various models of a power delivery system including a voltage regulator, in accordance with some embodiments.

FIGS. 5C-5D are schematic views of portions of conductance and capacitance matrices for a modified nodal analysis (MNA), in accordance with some embodiments.

FIGS. 6A-6B are circuit diagrams of various models of a power delivery system including a voltage regulator, in accordance with some embodiments.

FIGS. 7A-7C are flowcharts of various processes, in accordance with some embodiments.

FIG. 8 is a block diagram of an electronic design automation (EDA) system in accordance with some embodiments.

FIG. 9 is a block diagram of an IC device manufacturing system, and an IC manufacturing flow associated therewith, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Source/drain(s) may refer to a source or a drain, individually or collectively dependent upon the context.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In an IC design process, one or more pre-manufacturing verifications are directed to a power delivery system for the IC device being designed. A voltage regulator is a component in such a power delivery system, and is subject to one or more simulations during the design stage. For such simulations, a model of a voltage regulator (hereinafter “VR model”) is used.

In some embodiments, a VR model is configured to include no non-linear circuit components. Such a VR model, which is free of non-linear circuit components, is sometimes referred to as a linear VR model. In at least one example configuration, a linear VR model consists essentially of linear circuit components. Examples of linear circuit components in one or more embodiments include, but are not limited to, voltage sources, resistors, capacitors, inductors, or the like. Examples of non-linear circuit components in one or more embodiments include, but are not limited to, switches, control circuits, transistors, circuits containing one or more switches and/or transistors, or the like. In some embodiments, a linear VR model is used in one or more simulations of a voltage regulator and/or a power delivery system including the voltage regulator. In at least one embodiment, because the linear VR model includes no non-linear circuit components, it is possible to simplify the one or more simulations using the linear VR model, and reduce amounts of computing resources and/or time required to complete such simulations, thereby improving performances of one or more computer systems or processor executing the simulations. This is an improvement over other approaches in which a non-linear VR model with one or more non-linear circuit components is used in a simulation. Such a simulation is time-consuming and/or requires a large amount of computing resources due to the non-linear circuit components of the non-linear VR model. In some situations, a simulation using a non-linear VR model potentially takes days to complete. In contrast, it is possible to reduce the simulation time from days to minutes when the simulation is executed using a linear VR model in accordance with some embodiments.

In some embodiments, a linear VR model makes it possible and/or feasible to perform a co-simulation of a voltage regulator with other components of a power delivery system, such as, an input network coupled between an input of the voltage regulator and a power supply, and/or an output network coupled between an output of the voltage regulator and a load (e.g., circuitry of an IC device). In at least one embodiment, the co-simulation comprises an alternating current (AC) simulation (or AC analysis). Such an AC simulation of the power delivery system from the input network through the voltage regulator to the output network is not available and/or feasible in accordance with other approaches using a non-linear VR model. In some embodiments, model parameters of a linear VR model are incorporated into a modified nodal analysis (MNA) and/or a netlist to be used in a simulation. Other features, effects and/or advantages are within the scopes of various embodiments, as described herein.

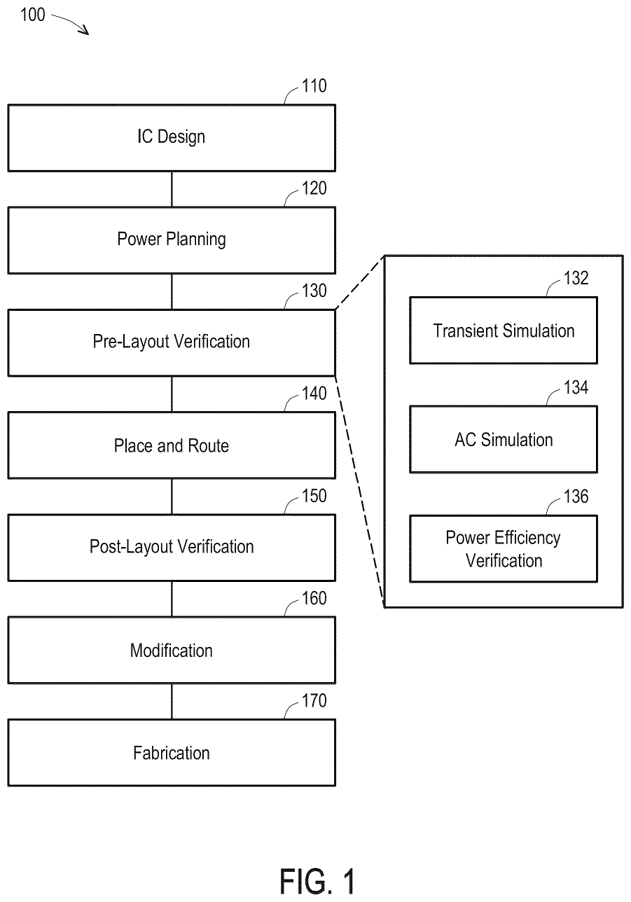

FIG. 1 is a functional flow chart of at least a portion of an IC design and fabrication process 100, in accordance with some embodiments. At least a part of the process 100 utilizes one or more electronic design automation (EDA) tools (or EDA systems) for generating, optimizing and/or verifying a design of an IC device before fabrication. The EDA tools, in some embodiments, are one or more sets of executable instructions for execution by one or more processors or controllers or programmed computers, as described herein, to perform the indicated functionality. In at least one embodiment, the process 100 is performed at least in part by a design house of an IC manufacturing system as discussed herein.

At IC design generation operation 110, an IC design of an IC device is provided or configured by a circuit designer. In some embodiments, the IC design of the IC device comprises an IC schematic, i.e., an electrical diagram, of the IC device. In some embodiments, the schematic is generated or provided in the form of a schematic netlist, such as a Simulation Program with Integrated Circuit Emphasis (SPICE) netlist. Other data formats, e.g., Verilog, for describing the design are usable in some embodiments.

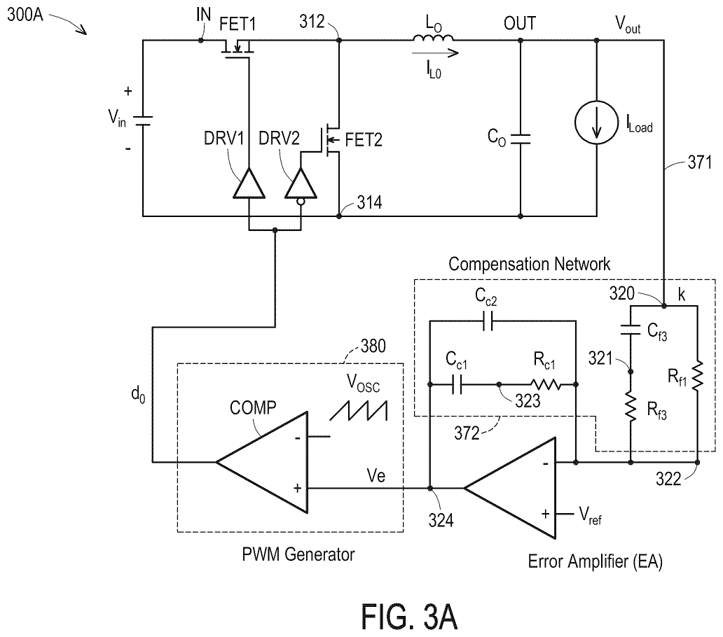

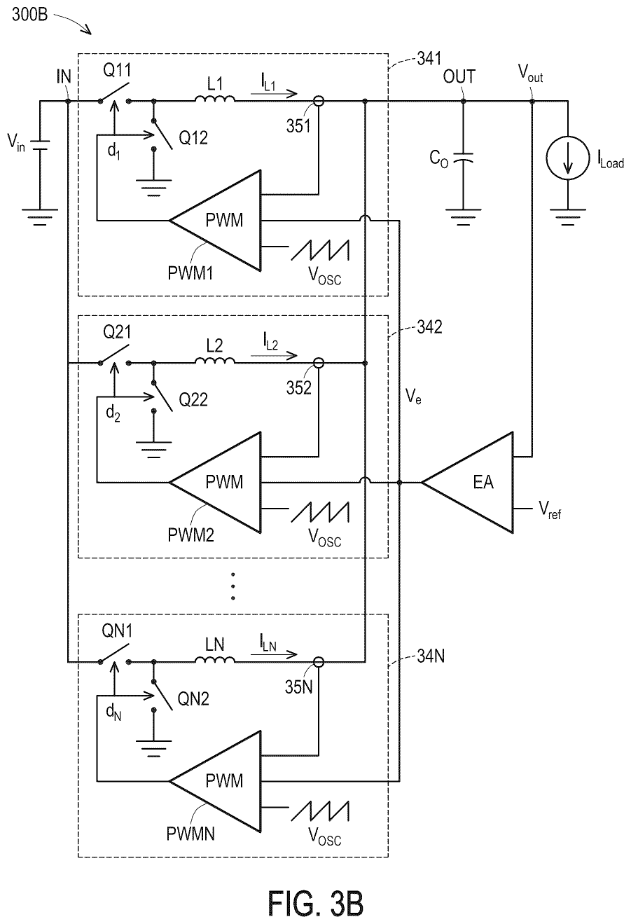

At power planning operation 120, a configuration of a power delivery system for the IC device is determined or designed. In some embodiments, a power delivery system comprises a voltage regulator between a power supply and a load (e.g., functional circuitry of the IC device). In at least one embodiment, the power delivery system further comprises at least one of an input network between the power supply and the voltage regulator, or an output network between the voltage regulator and the load. At the power planning operation 120, configurations of one or more of the voltage regulator, input network and output network are determined and/or estimated. Example configurations of voltage regulators are described with respect to FIGS. 3A, 3B. Example configurations of at least one of the input network or the output network include, but are not limited to, through silicon vias (TSVs), interconnect structures, power grid structures, or the like. In some embodiments, an interconnect structure or a TSV is configured to deliver power from one point to another point. In an example, an interconnect structure comprises metal patterns in one or more metal layers connected by conductive vias in one or more via layers. In at least one embodiment, a power grid structure is configured to deliver power over a wide area, e.g., over the whole or a part of the IC device. In an example, a power grid structure comprises elongated power rails in several metal layers. For example, first power rails in a first metal layer are elongated in a first direction, whereas second power rails in a different, second metal layer are elongated in a second direction orthogonal to the first direction. The first power rails in the first metal layer are coupled to the second power rails in the second metal layer by conductive vias at intersections (in plane view) of the first power rails and the second power rails. Other configurations of the input network and/or output network are within the scopes of various embodiments.

At pre-layout verification operation 130, one or more simulations and/or analyses are performed to determine whether one or more predetermined specifications and/or requirements are met. In the pre-layout verification operation 130, the IC design of the IC device provided or configured at the IC design generation operation 110 and/or the power delivery system configured at the power planning operation 120 is/are simulated. If the simulation results indicate that predetermined, the process proceeds to the next operation. If the specifications and/or requirements are not met, the IC design and/or the power delivery system is/are redesigned or re-configured. Example simulations and/or verifications performed in the pre-layout verification operation 130 include, but are not limited to, a transient simulation 132, an AC simulation 134, a power efficiency verification 136, or the like.

In at least one embodiment, the transient simulation 132 is configured to estimate and/or evaluate the behavior of the IC device over time, i.e., in the time domain. For example, the transient simulation 132 is performed to obtain transient waveforms at the various nodes, and the minimum and maximum voltages for each of the nodes are extracted from the transient waveforms. The extracted minimum and maximum voltages are used to determine whether one or more predetermined specifications and/or requirements are met.

In at least one embodiment, the AC simulation 134 is configured to estimate and/or evaluate the behavior of the IC device across a frequency range of the IC design, i.e., in the frequency domain. For example, small signals are input across the frequency range to verify the IC design's frequency response and/or gain characteristics which are used to determine whether one or more predetermined specifications and/or requirements are met. In at least one embodiment, for the AC simulation 134, a small signal model of a voltage regulator is used.

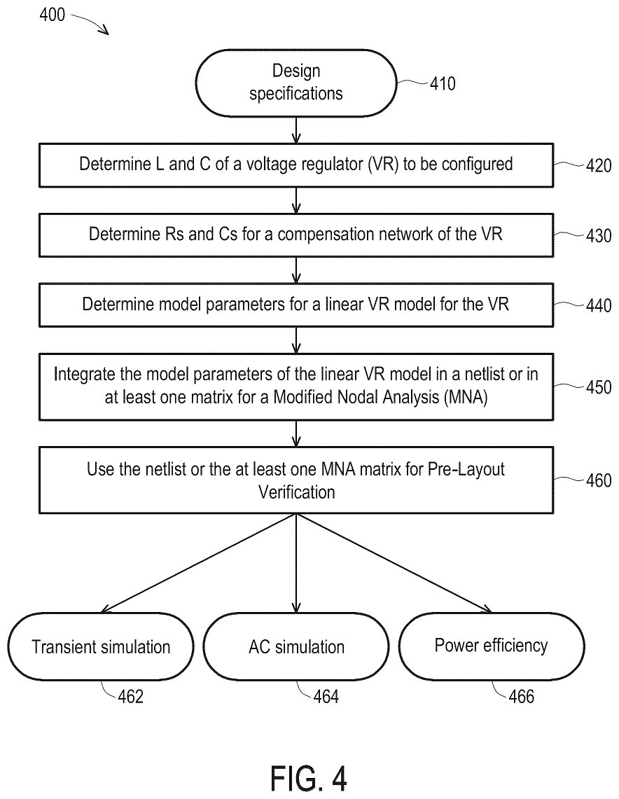

In at least one embodiment, the power efficiency verification 136 is configured to estimate and/or evaluate whether a power efficiency of the voltage regulator in particular, or the power delivery system as a whole, meets a predetermined specification and/or requirement. Further details regarding power efficiency calculation and/or verification are discussed with respect to FIG. 4. In some embodiments, the power efficiency verification 136 is configured to further estimate and/or evaluate one or more other power indicators or parameters of the voltage regulator or the power delivery system. The described simulations and/or verifications in the pre-layout verification operation 130 are examples. In some embodiments, the pre-layout verification operation 130 comprises one or more further simulations and/or verifications. In some embodiments, one or more of the transient simulation 132, AC simulation 134, power efficiency verification 136 is/are omitted.

At cell placement and routing (or Place and Route) operation 140, a layout (also referred to as “IC layout”) of the IC device is generated based on the IC schematic. The cell placement and routing operation 140 is sometimes referred to as Automatic Placement and Routing (APR) in at least one embodiment. The IC layout comprises physical positions of various circuit elements of the IC device as well as physical positions of various nets interconnecting the circuit elements. For example, the IC layout is generated in the form of a Graphic Design System (GDS) or GDSII file. Other data formats, e.g., Design Exchange Format (DEF), for describing the design of the IC device are within the scope of various embodiments. In at least one embodiment, the IC layout is generated by an EDA tool, such as an APR tool. Example operations by the APR tool include, but are not limited to, a cell placement operation and a routing operation.

In a cell placement operation, the APR tool performs cell placement. Cells configured to provide pre-defined functions and having pre-designed layouts are stored in one or more cell libraries, for example, in Library Exchange Format (LEF). LEF is a specification that includes design rules and information about cells in a library. In at least one embodiment, LEF is used with DEF to represent a physical layout of an IC being designed. The APR tool accesses various cells from one or more cell libraries, and places the cells in an abutting manner to generate an IC layout corresponding to the IC schematic. Each cell includes one or more circuit elements and/or one or more nets. A circuit element (also referred to as “circuit device”) is an active element (also referred to as “active device”) or a passive element (also referred to as “passive device”). Examples of active elements include, but are not limited to, transistors and diodes. Examples of transistors include, but are not limited to, metal oxide semiconductor field effect transistors (MOSFETs), complementary metal oxide semiconductor (CMOS) transistors, bipolar junction transistors (BJTs), high voltage transistors, high frequency transistors, p-channel and/or n-channel field effect transistors (PFETs/NFETs), FinFETs, planar MOS transistors with raised source/drains, nanosheet FETs, nanowire FETs, or the like. Examples of passive elements include, but are not limited to, capacitors, inductors, fuses, and resistors. Examples of nets include, but are not limited to, vias, conductive pads, conductive traces, and conductive redistribution layers, or the like. Examples of cells include, but are not limited to, AND, OR, NAND, NOR, XOR, INV, OR-AND-Invert (OAI), MUX, Flip-flop, BUFF, Latch, delay, clock, memory such as static random-access memory (SRAM), de-coupling capacitor, analog amplifier, logic driver, digital driver, or the like. In some embodiments, passive elements are examples of linear circuit components, and/or active elements are examples of non-linear circuit components.

In a routing operation, the APR tool performs routing to route various nets interconnecting the placed circuit elements. The routing is performed to ensure that the routed interconnections or nets satisfy a set of constraints. For example, the routing operation includes global routing, track assignment and detailed routing. During the global routing, routing resources used for interconnections or nets are allocated. For example, the routing area is divided into a number of sub-areas, pins (or terminals) of the placed circuit elements are mapped to the sub-areas, and nets are constructed as sets of sub-areas in which interconnections are physically routable. During the track assignment, the APR tool assigns interconnections or nets to corresponding conductive layers of the IC layout. During the detailed routing, the APR tool routes interconnections or nets in the assigned conductive layers and within the global routing resources. For example, detailed, physical interconnections are generated within the corresponding sets of sub-areas defined at the global routing and in the conductive layers defined at the track assignment. After the routing operation, the APR tool outputs the IC layout including the placed circuit elements and routed nets. The described APR tool is an example. Other arrangements are within the scope of various embodiments. For example, in one or more embodiments, one or more of the described operations are omitted or one or more additional operations are added before, during, or after the described operations.

At post-layout verification operation 150, one or more verifications are performed after the cell placement and routing operation 140. Example verifications include, but are not limited to, a layout-versus-schematic (LVS) check, a design rule check (DRC), a timing analysis, or the like. Other verification processes are usable in various embodiments. An LVS check is performed, e.g., by an EDA tool, to ensure that the generated IC layout corresponds to the design of the IC device. A DRC is performed, e.g., by an EDA tool, to ensure that the IC layout satisfies certain manufacturing design rules, i.e., to ensure manufacturability of the IC device. A timing analysis is performed to estimate and check whether delays in a plurality of paths in the IC layout satisfy predetermined timing requirements. When the checks and/or verifications at the post-layout verification operation 150 are passed, the process proceeds to fabrication operation 170. If a check or verification fails, a modification is made to the IC layout, e.g., at modification operation 160.

At the modification operation 160, a modification is made directly or indirectly to the IC layout. In some embodiments, the process is returned to the cell placement and routing operation 140 to directly make a modification to the IC layout. In at least one embodiment, the process is returned to the IC design generation operation 110 to change the IC device design which, in turn, will result in a modification being indirectly made to the IC layout. Once one or more modifications have been made to the IC layout, one or more verifications at the post-layout verification operation 150 are performed again to ensure that the modified IC layout satisfies all design rules, timing requirements, or the like. In some situations, the described modification-verification process is repeated one or more times until it is determined that the IC layout is ready for manufacture and the process proceeds to the fabrication operation 170, or it is determined that the IC layout despite the modifications does not satisfy all requirements and needs to be redesigned. The process 100 in FIG. 1 is an example. In some embodiments, the IC device design flow 100 includes one or more further operations, and/or one or more of the described operations are omitted.

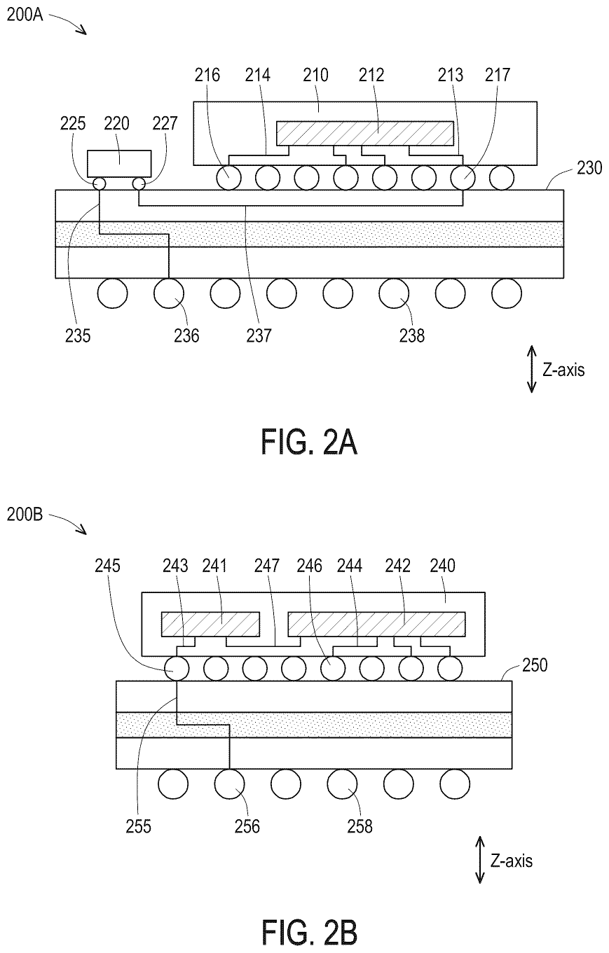

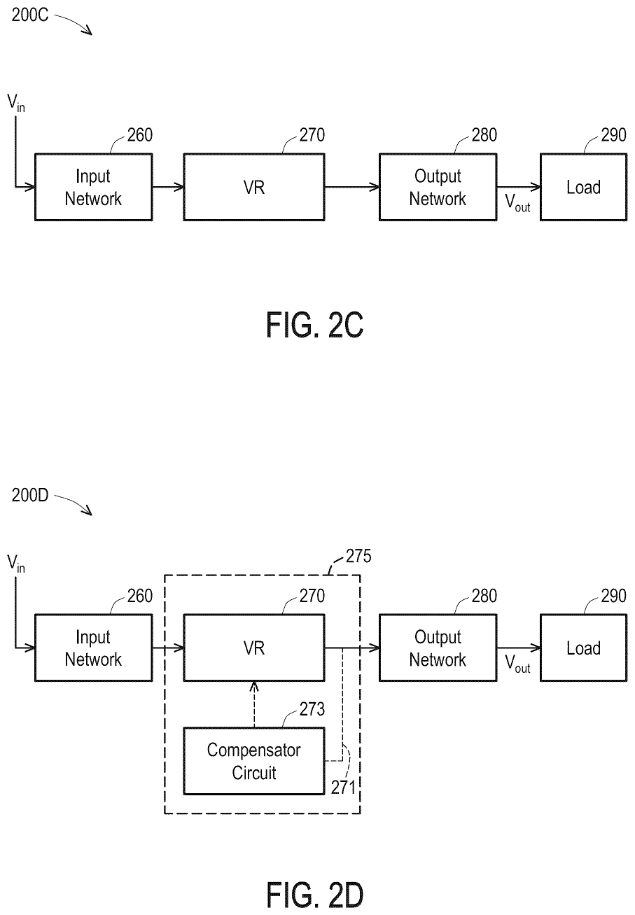

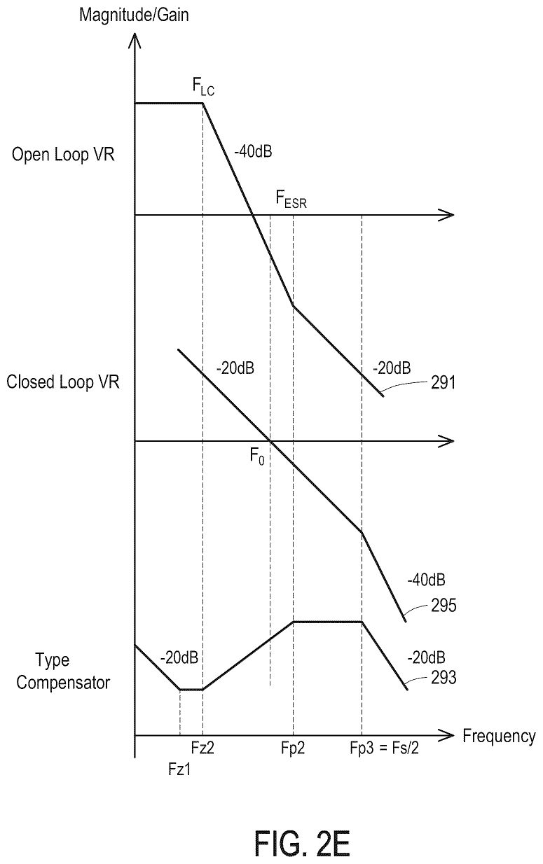

FIG. 2A is a schematic cross-sectional views of a semiconductor device 200A, in accordance with some embodiments.

The semiconductor device 200A comprises a die or chip 210, a voltage regulator 220, and substrate 230. The chip 210 and the voltage regulator 220 are stacked, along a thickness direction (Z direction), on the substrate 230, and are electrically and mechanically coupled to the substrate 230 in a three-dimensional (3D) IC configuration.

The chip 210 comprises circuitry 212, a redistribution structure including various interconnect structures 213, 214, and a plurality of bumps 216, 217. In some embodiments, the chip 210 corresponds to the IC device being designed and manufactured in accordance with the process 100, and/or the circuitry 212 corresponds to the circuitry of the IC device. In at least one embodiment, the chip 210 comprises a system-on-chip (SOC). The redistribution structure of the chip 210 comprises a plurality of metal layers and a plurality of via layers alternatingly arranged along the Z direction. A set of metal patterns in one or more metal layers is coupled with each other by one or more conductive vias in the intervening via layers to form an interconnect structure. Various interconnect structures are formed in the redistribution structure of the chip 210 to couple circuit elements of the circuitry 212 with each other, and/or with external circuitry through corresponding bumps. For example, the interconnect structure 213 couples the circuitry 212 to the bump 217, or the interconnect structure 214 couples the circuitry 212 to the bump 216. The bumps 216, 217 electrically couple and mechanically bond the chip 210 to the substrate 230.

The voltage regulator 220 comprises a plurality of bumps 225, 227 which correspond to an input and an output of the voltage regulator 220. The bumps 225, 227 electrically couple and mechanically bond the voltage regulator 220 to the substrate 230. The substrate 230 is configured to electrically couple the voltage regulator 220 to the chip 210, as described herein. In some embodiments, the voltage regulator 220 corresponds to the voltage regulator configured and/or verified in the process 100, and/or the circuitry 212 corresponds to a load of the voltage regulator 220.

The substrate 230 comprises a redistribution structure having various interconnect structures 235, 237, and a plurality of bumps 236, 238. In some embodiments, the redistribution structure and/or interconnect structures of the substrate 230 are configured similarly to the redistribution structure and/or interconnect structures of the chip 210. In some embodiments, the substrate 230 comprises a die or chip with its own circuitry (not shown) coupled to the voltage regulator 220 and/or the circuitry 212. In at least one embodiment, the substrate 230 comprises an interposer configured to be bonded by the bumps 236, 238 on another substrate, interposer or die (not shown).

The interconnect structure 235 of the substrate 230 electrically couples the bump 225 corresponding to the input of the voltage regulator 220 to the bump 236 configured to be coupled to a power supply (not shown). The interconnect structure 235 and the bumps 225, 236 constitute an example of an input network coupled between the input of the voltage regulator 220 and the power supply. Other input network configurations are within the scopes of various embodiments. In one or more embodiments, for the purpose of one or more simulations described herein, at least one of the bumps 225, 236 is not considered as part of the input network where any effect of the bump 225 and/or the bump 236 on the simulation results is negligible. In at least one embodiment, the input network comprises, in lieu of the interconnect structure 235 or a part thereof, a TSV extending in the Z direction through the substrate 230. In some embodiments, the semiconductor device 200A comprises a more complex input network with various interconnect structures, TSVs, bumps, and/or other power delivery structures. In some embodiments, for the purpose of one or more simulations described herein, the entire input network is omitted, e.g., where the interconnect structure 235 or a corresponding TSV is short, or has a negligible effect on the simulation results.

The interconnect structure 237 of the substrate 230 electrically couples the bump 227 corresponding to the output of the voltage regulator 220 to the bump 217 of the chip 210. As described herein, the bump 217 is coupled by the interconnect structure 213 to the circuitry 212, thereby delivering power from the output of the voltage regulator 220 to the load, i.e., the circuitry 212 of the chip 210. The interconnect structures 237, 213 and the bumps 227, 217 constitute an example of an output network coupled between the output of the voltage regulator 220 and the load. Other output network configurations are within the scopes of various embodiments. In one or more embodiments, at least one of the bumps 217, 227 or the interconnect structure 213 is not considered as part of the output network where any effect of the bump 217 and/or the bump 227 and/or the interconnect structure 213 on the simulation results is negligible. In some embodiments, the semiconductor device 200A comprises a more complex output network with various interconnect structures, bumps, power grid structures and/or other power delivery structures. In some embodiments, for the purpose of one or more simulations described herein, the entire output network is omitted, e.g., where the interconnect structures 237, 213 are short, or have a negligible effect on the simulation results.

The described configuration of the semiconductor device 200A is an example. Other semiconductor device configurations are within the scopes of various embodiments. For example, in some embodiments, the voltage regulator 220 is stacked on, and bonded to, the chip 210. In at least one embodiment, the voltage regulator 220 is arranged on, and bonded to, a lower side of the substrate 230 or the lower side of the chip 210, i.e., the side on which the bumps 236, 238 (or the bumps 216, 217) are arranged. In some embodiments, the voltage regulator 220 comprises an output inductor and/or an output capacitor electrically coupled to the output of the voltage regulator 220. In at least one embodiment, at least one of the output inductor or the output capacitor is a component (not shown) physically separate from a remaining circuit of the voltage regulator 220 exemplarily illustrated in FIG. 2A. Such physically separate output inductor and/or the output capacitor is/are coupled and bonded to the chip 210, the voltage regulator 220 (as exemplarily illustrated in FIG. 2A) or the substrate 230 by a separate set of bumps. In at least one embodiment, at least one of the output inductor or the output capacitor is embedded in the substrate 230.

FIG. 2B is a schematic cross-sectional views of a semiconductor device 200B, in accordance with some embodiments. Compared to the semiconductor device 200A where the voltage regulator 220 is a component physically separated from the chip 210 comprising the load (i.e., the circuitry 212), the semiconductor device 200B comprises a voltage regulator incorporated in a same chip as a load of the voltage regulator.

The semiconductor device 200B comprises a chip 240, and substrate 250. The chip 240 is stacked, along a thickness direction (Z direction), on the substrate 250, and is electrically and mechanically coupled to the substrate 250 in a three-dimensional (3D) IC configuration.

The chip 240 comprises a voltage regulator 241, circuitry 242, a redistribution structure including various interconnect structures 243, 244, 247, and a plurality of bumps 245, 246. The substrate 250 comprises a redistribution structure having various interconnect structures one of which is designated as 255, and a plurality of bumps 256, 258. The interconnect structure 243 electrically couples an input (not numbered) of the voltage regulator 241 to the bump 245 which is further coupled by the interconnect structure 255 to the bump 256 configured to be coupled to a power supply (not shown). The interconnect structure 247 electrically couples an output (not numbered) of the voltage regulator 241 to the circuitry 242. In some embodiments, the voltage regulator 241 and the circuitry 242 correspond to the voltage regulator 220 and the circuitry 212, i.e., the circuitry 242 comprises a load of the voltage regulator 241.

The interconnect structures 243, 255 and the bumps 245, 256 constitute an example of an input network coupled between the input of the voltage regulator 241 and the power supply. Other input network configurations are within the scopes of various embodiments. In one or more embodiments, for the purpose of one or more simulations described herein, at least one of the bumps 245, 256, and/or at least one of the interconnect structures 243, 255 is not considered as part of the input network where any effect of the bump 245, the bump 256, the interconnect structure 243, and/or the interconnect structure 255 on the simulation results is negligible. In at least one embodiment, the input network comprises, in lieu of the interconnect structure 255 or a part thereof, a TSV extending in the Z direction through the substrate 250. In some embodiments, the semiconductor device 200B comprises a more complex input network with various interconnect structures, TSVs, bumps, and/or other power delivery structures. In some embodiments, for the purpose of one or more simulations described herein, the entire input network is omitted.

The interconnect structure 247 constitutes an example of an output network coupled between the output of the voltage regulator 241 and the load (i.e., the circuitry 242). Other output network configurations are within the scopes of various embodiments. In some embodiments, the semiconductor device 200B comprises a more complex output network with various interconnect structures, power grid structures and/or other power delivery structures. In some embodiments, for the purpose of one or more simulations described herein, the entire output network is omitted.

In some embodiments, the semiconductor device 200B further comprises an output inductor and/or an output capacitor which is a component (not shown) physically separate from a remaining circuit of the voltage regulator 241 exemplarily illustrated in FIG. 2B. Such physically separate output inductor and/or the output capacitor is/are coupled and bonded to the chip 240 or the substrate 250 by a separate set of bumps. In at least one embodiment, at least one of the output inductor or the output capacitor is embedded in the substrate 250.

The semiconductor devices 200A, 200B are examples of semiconductor devices comprising integrated voltage regulators (IVRs). In the described examples, the IVR is in the same die as the load (FIG. 2B), or is outside the die containing the load but in the same package (FIG. 2A). Other IVR configurations are within the scopes of various embodiments. A non-IVR is often a voltage regulator in a separate package and is coupled to the package containing the load through metal traces on a printed circuit board (PCB). Compared to non-IVRs, an IVR is arranged closer to the load (i.e., circuitry of an IC device), thereby eliminating or at least reducing undesirable effects of parasitic inductance and/or parasitic capacitance due to pins, bumps, packages, and PCB traces. As a result, it is possible in one or more embodiments for an IVR to provide one or more advantages over a non-IVR including, but not limited to, reduced inductance and/or capacitance of an output inductor and/or output capacitor, higher operating frequency, improved dynamic response, reduced power supply noise, or the like.

FIG. 2C is a block diagram of a power delivery system 200C, in accordance with some embodiments. In some embodiments, the power delivery system 200C is configured with, and/or to deliver power to, an IC device, as described herein.

The power delivery system 200C comprises an input network 260, a voltage regulator (VR) 270, and an output network 280. The input network 260 is coupled between a power supply (represented by an input voltage Vᵢₙ) and an input of the voltage regulator 270. The output network 280 is coupled between an output of the voltage regulator 270 and a load 290. In some embodiments, the input network 260 corresponds to one or more input networks described with respect to FIGS. 2A-2B, the voltage regulator 270 corresponds to one or more of the voltage regulators 220, 241, the output network 280 corresponds to one or more output networks described with respect to FIGS. 2A-2B, and/or the load 290 corresponds to one or more of the loads described with respect to FIGS. 2A-2B, i.e., the circuitry 212, 242.

The voltage regulator 270 is configured to convert the input voltage Vᵢₙ received through the input network 260 to an output voltage Vₒᵤₜ, and to deliver the output voltage Vₒᵤₜ through the output network 280 to the load 290. In some embodiments, the voltage regulator 270 is configured to provide a steady and reliable output voltage Vₒᵤₜ despite changes in the input voltage Vᵢₙ and/or the load 290. In one or more embodiments described herein, the voltage regulator 270 is a buck converter configured for a voltage step-down, i.e., to output the output voltage Vₒᵤₜ at a voltage level or voltage value lower than the input voltage Vᵢₙ.

In the example configuration in FIG. 2C, the voltage regulator 270 is an open-loop voltage regulator which does not include feedback from the output of the voltage regulator. An example configuration of a closed-loop voltage regulator with feedback is described with respect to FIG. 2D.

FIG. 2D is a block diagram of a power delivery system 200D, in accordance with some embodiments. In some embodiments, the power delivery system 200D is configured with, and/or to deliver power to, an IC device, as described herein. Corresponding components in FIGS. 2C-2D are designated by the same reference numerals.

Compared to the power delivery system 200C, the power delivery system 200D comprises a voltage regulator 275 which is a closed-loop voltage regulator. In the example configuration in FIG. 2D, the closed-loop voltage regulator 275 is configured by adding, to the open-loop voltage regulator 270, a compensator circuit 273 in a feedback connection 271. Example circuits for the open-loop voltage regulator 270, the compensator circuit 273 and the closed-loop voltage regulator 275 are described with respect to FIGS. 3A.

In some embodiments, a simulation described herein, e.g., with respect to the pre-layout verification operation 130, comprises a co-simulation of the power delivery system 200C from the input network 260 through the voltage regulator 270 to the output network 280, or a co-simulation of the power delivery system 200D from the input network 260 through the voltage regulator 275 to the output network 280. In some embodiments, as described herein, at least one of the input network 260 or the output network 280 is omitted from a simulation of the pre-layout verification operation 130.

FIG. 2E includes Bode plots 291, 293, 295 of various components in a voltage regulator, in accordance with some embodiments.

Each of the Bode plots 291, 293, 295 shows a relationship of signal magnitude or gain with respect to frequency, for a corresponding component. Specifically, the Bode plot 291 shows the relationship for an open-loop voltage regulator, such as the voltage regulator 270. The Bode plot 293 shows the relationship for a compensator circuit, such as the compensator circuit 273. The Bode plot 295 shows the relationship for a closed-loop voltage regulator, such as the voltage regulator 275. By adding the compensator circuit 273 to the open-loop voltage regulator 270 to obtain the voltage regulator 275, the Bode plot 295 is obtained as a result of a combination of the Bode plot 291 and Bode plot 293.

The Bode plot 291 has parameters F_{LC} (also referred to as a “pole”) and F_{ESR} (also referred to as a “zero”) which depend on an output inductor and an output capacitor of the open-loop voltage regulator 270. The Bode plot 293 has a plurality of parameters referred to as poles Fp2, Fp3 and zeros Fz1, Fz2. The pole Fp3 is a half of a switching frequency Fs (also referred to herein as F_{sw}). The remaining pole and/or zeros of the Bode plot 293 depend on parameters of a compensation network in the compensator circuit 273. In the example configuration in FIG. 2E, the compensator circuit 273 comprises a type III compensator circuit, and comprises a compensation network of various resistors and capacitors. By configuring the parameters of the compensation network, it is possible to achieve desired poles and zeros in the Bode plot 293 and, as a result, achieve a desired frequency F₀ at which the Bode plot 295 passes through zero. The frequency F₀ is sometimes referred to as a bandwidth (BW) of the voltage regulator 275. The described type III compensator circuit is an example. Other compensator circuit configurations, such as type I compensator circuits, type II compensator circuits or any other types of compensator circuits, are within the scopes of various embodiments. In some embodiments where a closed-loop voltage regulator comprises a type III compensator circuit, it is possible to achieve unconditional stability for any type of output capacitors and over a wide range of equivalent series resistance (ESR) values of the output capacitor.

FIG. 3A is a circuit diagram of a voltage regulator 300A, in accordance with some embodiments. In some embodiments, the voltage regulator 300A corresponds to one or more voltage regulators described with respect to one or more of FIGS. 1 and 2A-2E. In the example configuration in FIG. 3A, the voltage regulator 300A is a buck converter.

The voltage regulator 300A comprises an input IN, an output OUT, power switches FET1, FET2, a driving circuit comprising drivers DRV1, DRV2, an output inductor L_{O}, an output capacitor C_{O}, a feedback connection 371, a compensator circuit comprising a compensation network 372 and an error amplifier EA, and a control circuit comprising a pulse-width modulation (PWM) generator 380.

The input IN is configured to receive an input voltage Vᵢₙ from a power supply. The output OUT is configured to output an output voltage Vₒᵤₜ corresponding to the input voltage Vᵢₙ to a load which is schematically represented by a current source I_{Load}. In some embodiments, the load schematically represented by the current source I_{Load} corresponds to the load 290. In at least one embodiment, the voltage regulator 300A is configured such that variations of I_{Load}, which is the actual current drawn by the load (e.g., circuitry of a chip) and is expected to fluctuate depending on the chip's activities, do not change the output voltage Vₒᵤₜ beyond a predetermined, acceptable limit, thereby satisfying an objective of the voltage regulator.

The power switch FET1 has one source/drain coupled to the input IN, another source/drain coupled to a node 312, and a gate coupled to an output of the corresponding driver DRV1. The power switch FET2 has one source/drain coupled to the ground at a node 314, another source/drain coupled to the node 312, and a gate coupled to an output of the corresponding driver DRV2. Sometimes, the power switches FET1 and FET2 are referred correspondingly to as a high-side switch and a low-side switch. In some embodiments, the power switches FET1, FET2 are metal oxide semiconductor field effect transistors (MOSFETs), or insulated-gate bipolar transistors (IGBTs). Other switch or transistor configurations are within the scopes of various embodiments.

The output inductor L_{O} has a first end coupled to the node 312, and a second end coupled to the output OUT. The output capacitor C_{O} has a first end coupled to the node 314, and a second end coupled to the output OUT. In some embodiments, as described with respect to FIGS. 2A, 2B, at least one of the output inductor L_{O} or the output capacitor C_{O} is a component physically separate from the remaining components of the voltage regulator 300A.

The compensation network 372 is coupled between the output OUT and the PWM generator 380. The compensation network 372 comprises capacitors C_{c1}, C_{c2}, C_{f3}, and resistors R_{c1}, R_{f1}, R_{f3}. The resistor Rf has a first end coupled to a node 320 which is coupled to the output OUT by the feedback connection 371, and a second end coupled to a node 322. The capacitor C_{f3} has a first end coupled to the node 320, and a second end coupled to a node 321. The resistor R_{f3} has a first end coupled to the node 321, and a second end coupled to the node 322. The capacitor C_{c2} has a first end coupled to the node 322, and a second end coupled to a node 324. The capacitor C_{c1} has a first end coupled to a node 323, and a second end coupled to the node 324. The resistor R_{c1} has a first end coupled to the node 322, and a second end coupled to the node 323.

In the example configuration in FIG. 3A, the error amplifier EA is an operational amplifier. The error amplifier EA has an inverting input coupled to the node 322, a non-inverting input configured to receive a predetermined reference voltage V_{ref}, and an output coupled to the node 324. The error amplifier EA is configured to output an error voltage Ve corresponding to an output voltage Vₒᵤₜ at the output OUT.

The PWM generator 380 comprises a comparator COMP. In the example configuration in FIG. 3A, the comparator COMP is an operational amplifier. The comparator COMP has an inverting input configured to receive a saw-tooth voltage V_{OSC}, a non-inverting input coupled at the node 324 to the output of the error amplifier EA, and an output coupled to inputs of the drivers DRV1, DRV2. In at least one embodiment, each of the drivers DRV1, DRV2 comprises one or more transistors. In some embodiments, the control circuit of the voltage regulator 300A further comprises a saw-tooth voltage generation circuit (not shown) including an oscillator and configured to generate the saw-tooth voltage V_{OSC}. In at least one embodiment, the saw-tooth voltage V_{OSC} is provided by a saw-tooth voltage generation circuit outside the voltage regulator 300A.

The comparator COMP of the PWM generator 380 is configured to compare the error voltage Ve output from the error amplifier EA with the saw-tooth voltage V_{OSC} and, based on the comparison, output a PWM control signal do (sometimes also referred to as duty cycle command) to the inputs of the drivers DRV1, DRV2. The input of the driver DRV1 is a non-inverting input and, as a result, the driver DRV1 is configured to drive (e.g., turn ON) the power switch FET1 in accordance with the PWM control signal do. The input of the driver DRV2 is an inverting input and, as a result, the driver DRV2 is configured to drive (e.g., turn ON) the power switch FET2 in accordance with an inverted version of the PWM control signal d₀. In some embodiments, the power switches FET1, FET2 are not turned ON by the corresponding drivers DRV1, DRV2 at the same time.

When the power switch FET1 is turned ON, the power switch FET2 is turned OFF. During the ON time of the power switch FET1, which corresponds to a duty ratio of the PWM control signal d₀, the input voltage Vᵢₙ is supplied through the turned ON power switch FET1 and the output inductor L_{O} to the load through the output OUT. An inductor current I_{L0} flowing through the output inductor L_{O} is gradually increased. The output inductor L_{O} and the output capacitor C_{O} store a part of the energy during the ON time of the power switch FET1.

When the power switch FET2 is turned ON, the power switch FET1 is turned OFF. During the ON time of the power switch FET2, the energy stored in the output inductor L_{O} and/or the output capacitor C_{O} is provided to the load through the output OUT. The inductor current I_{L0} flowing through the output inductor L_{O} is gradually decreased. The rise and fall of the inductor current I_{L0} is sometimes referred to as a ripple current or current ripple. The output voltage Vₒᵤₜ has a similar voltage ripple due to the switching operations of the power switches FET1, FET2.

The error amplifier EA is configured to generate the error voltage Ve corresponding to the output voltage Vₒᵤₜ and the resistors and capacitors in the compensation network 372. The comparator COMP of the PWM generator 380 is configured to compare the error voltage Ve output from the error amplifier EA with the saw-tooth voltage V_{OSC} and, based on the comparison, adjust the duty ratio of the PWM control signal d₀ which, in turn, adjusts the ON time of the power switch FET1, thereby controlling the output voltage Vₒᵤₜ to be stable or substantially stable.

In the example configuration in FIG. 3A, the voltage regulator 300A is a closed-loop voltage regulator. In some embodiments, the voltage regulator 300A corresponds to the closed-loop voltage regulator 275, the feedback connection 371 corresponds to the feedback connection 271, and the compensation network 372 corresponds to a compensation network of the compensator circuit 273. In at least one embodiment, the feedback connection 371 and the compensator circuit comprising the compensation network 372 and the error amplifier EA are omitted, and the voltage regulator 300A becomes an open-loop voltage regulator corresponding to, e.g., the open-loop voltage regulator 270. The described configuration and operation of the voltage regulator 300A are examples. Other voltage regulator configurations and/or operations are within the scopes of various embodiments. For example, although the control circuit of the voltage regulator 300A is described to implement PWM control through the PWM generator 380, a different control, e.g., pulse frequency modulation (PFM), is implemented in one or more embodiments.

In the example configuration in FIG. 3A, the voltage regulator 300A is a single-phase voltage regulator. An example configuration of a multi-phase voltage regulator is described with respect to FIG. 3B.

FIG. 3B is a circuit diagram of a voltage regulator 300B, in accordance with some embodiments. In some embodiments, the voltage regulator 300A corresponds to one or more voltage regulators described with respect to one or more of FIGS. 1 and 2A-2E. Corresponding components in FIGS. 3A-3B are designated by the same reference numerals.

Compared to the voltage regulator 300A which is a single-phase voltage regulator, the voltage regulator 300B is a multi-phase voltage regulator comprising N voltage regulator circuits 341, 342, . . . 34N corresponding to N phases of the voltage regulator 300B, where N is a natural number greater than 1. When N=1, the voltage regulator 300B becomes a single-phase voltage regulator corresponding to the voltage regulator 300A. Each of the voltage regulator circuits 341, 342, . . . 34N comprises a high-side switch Q11, Q21, . . . . QN1, a low-side switch Q12, Q22, . . . . QN2, an output inductor L1, L2, . . . . LN, a PWM generator PWM1, PWM2, . . . . PWMN configured to output a corresponding PWM control signal d₁, d₂, . . . d_{N}, and a sensing circuit or element schematically illustrated at 351, 352, . . . 35N and configured to detect a corresponding inductor current I_{L1}, I_{L2}, . . . . I_{LN} flowing through the corresponding output inductor L1, L2, . . . . LN. In some embodiments, for each of the voltage regulator circuits 341, 342, . . . 34N, the high-side switch Q11, Q21, . . . . QN1 corresponds to the power switch FET1, the low-side switch Q12, Q22, . . . . QN2 corresponds to the power switch FET2, the output inductor L1, L2, . . . . LN corresponds to the output inductor L_{O}, the inductor current I_{L1}, I_{L2}, . . . I_{LN} corresponds to the inductor current I_{L0}, the PWM generator PWM1, PWM2, . . . . PWMN corresponds to the PWM generator 380, and the PWM control signal d₁, d₂, . . . d_{N} corresponds to the PWM control signal d₀.

For simplicity various features of the voltage regulator 300B are not shown in FIG. 3B. For example, each of the voltage regulator circuits 341, 342, . . . 34N comprises a first driver (not shown) corresponding to the driver DRV1 and configured to drive the high-side switch Q11, Q21, . . . . QN1 based on the PWM control signal d₁, d₂, . . . d_{N}. Each of the voltage regulator circuits 341, 342, . . . 34N further comprises a second driver corresponding to the driver DRV2 and configured to drive the low-side switch Q12, Q22, . . . . QN2 based on an inverted version of the PWM control signal d₁, d₂, . . . d_{N}. In some embodiments, the voltage regulator 300B further comprises a compensation network coupled between an input and an output of the error amplifier EA. In an example configuration, such a compensation network corresponds to the compensation network 372.

In each of the voltage regulator circuits 341, 342, . . . 34N, the PWM generator PWM1, PWM2, . . . . PWMN is configured to, based on the saw-tooth voltage V_{OSC}, the error voltage Ve and a signal corresponding to the inductor current I_{L1}, I_{L2}, . . . I_{LN} sensed by the sensing circuit or element 351, 352, . . . 35N, generate the PWM control signal d₁, d₂, . . . d_{N} with a corresponding duty ratio and a corresponding phase. In some embodiments, the phases of the PWM control signal d₁, d₂, . . . d_{N} are different from each other, and are separated from each other by an interval of 360 degrees/N. The described multi-phase voltage regulator configuration is an example. Other multi-phase voltage regulator configurations are within the scopes of various embodiments.

FIG. 4 is a flowchart of a process 400 of configuring, modeling and verifying a voltage regulator, in accordance with some embodiments. In some embodiments, the process 400 is performed at least partially by a computer system or a processor, as described herein.

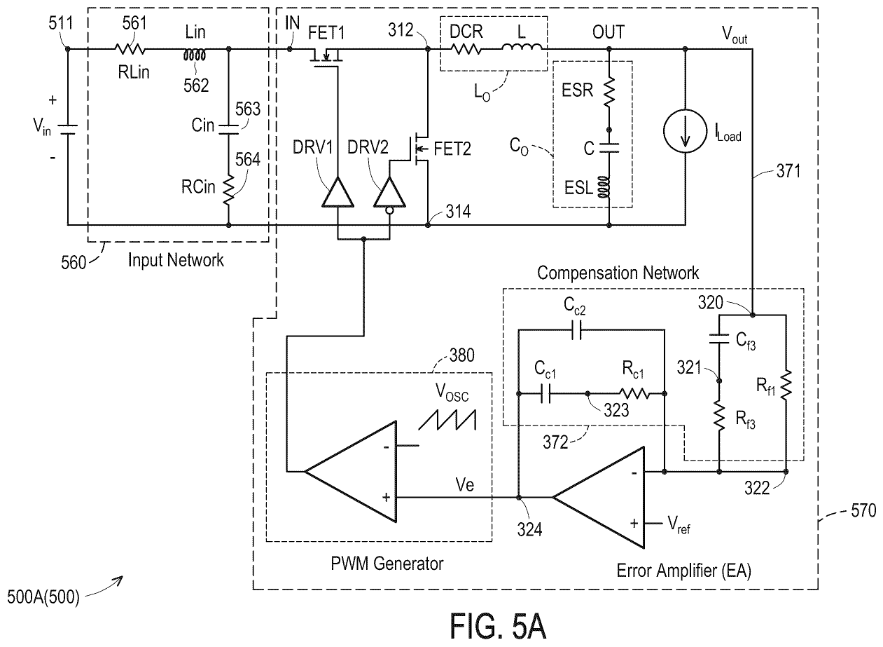

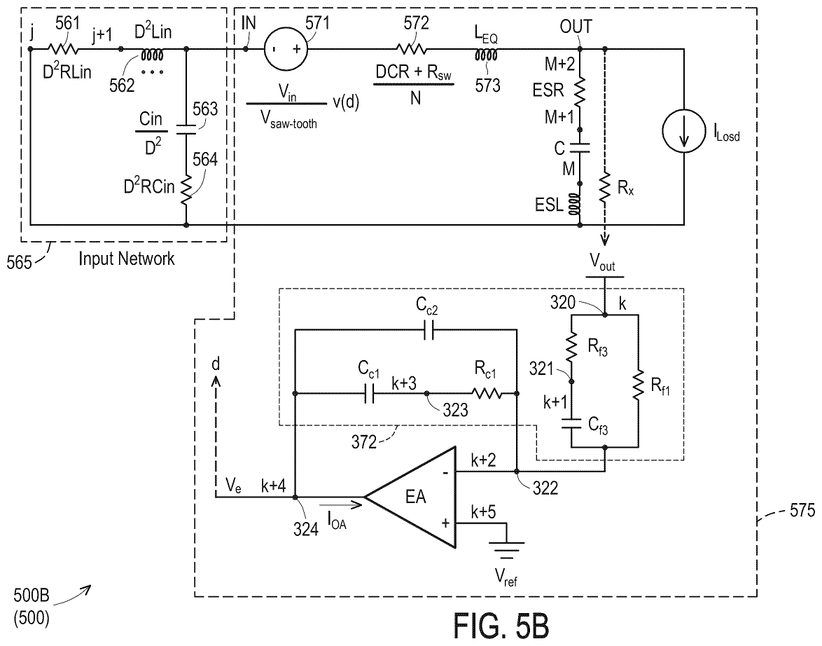

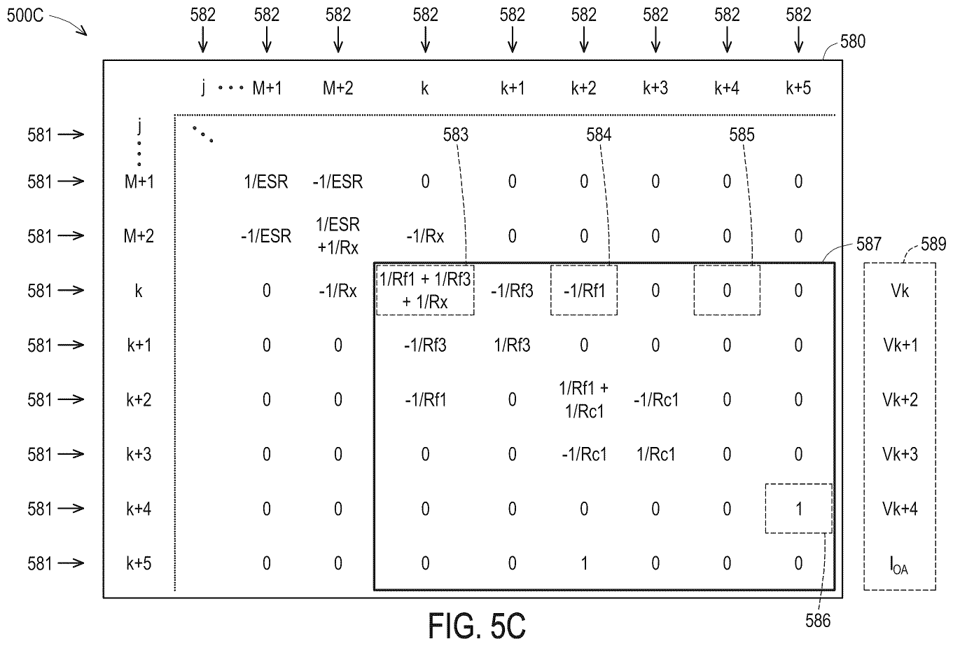

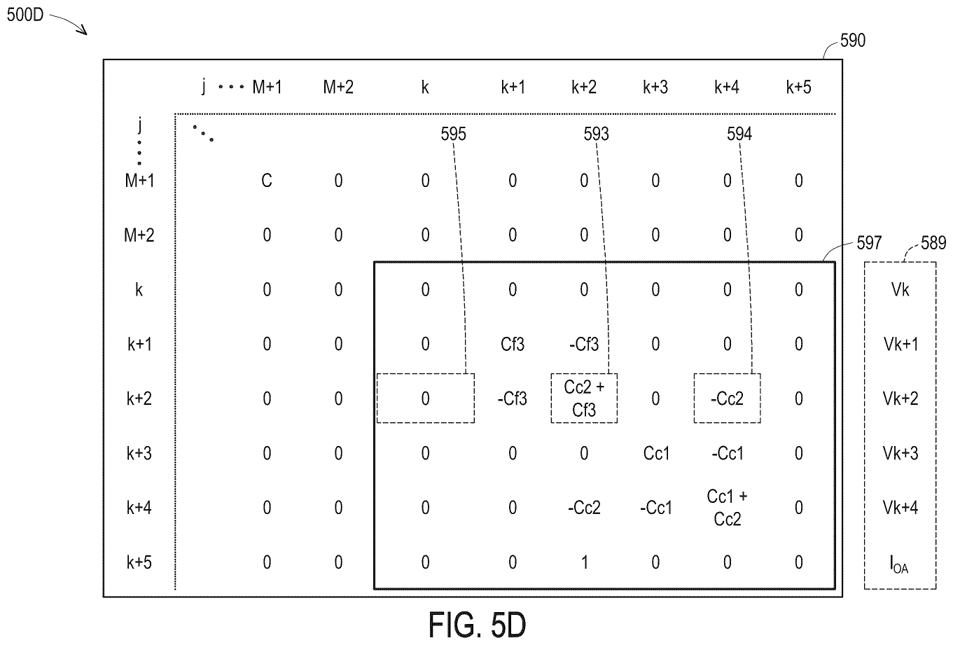

The process 400 in the FIG. 4 will be described with references to FIGS. 2E, 3A-3B, 5A-5D. FIGS. 5A-5B are circuit diagrams of various models of a power delivery system including the voltage regulator, in accordance with some embodiments. FIGS. 5C-5D are schematic views of portions of conductance and capacitance matrices for a modified nodal analysis (MNA) for a simulation of the voltage regulator, in accordance with some embodiments. In some embodiments, the voltage regulator and/or the power delivery system described with respect to FIGS. 4, 5A-5D correspond to one or more voltage regulators and/or one or more power delivery systems described with respect to one or more of FIGS. 1, 2A-2E, 3A-3B. Corresponding components in FIGS. 2E, 3A-3B, 5A-5D are designated by the same reference numerals. In example embodiments described herein with references to FIGS. 2E, 3A-3B, 5A-5D, the voltage regulator to be configured, modeled and verified in the process 400 of FIG. 4 corresponds to the voltage regulator 300A and/or voltage regulator 300B. For simplicity, the voltage regulator 300A is referred to in the following description of the example embodiments. The described example embodiments are also applicable to the voltage regulator 300B.

At operation 410 in the process 400, design specifications of a voltage regulator 300A to be configured are received.

In some embodiments, one or more of the design specifications are provided by a human circuit designer. In at least one embodiment, one or more of the design specifications are predetermined and loaded from a library and/or from a previously designed voltage regulator. In some embodiments, one or more of the design specifications are manually input or automatically loaded into a computer system as described herein. Examples of the design specifications include, but are not limited to, input voltage Vᵢₙ, output voltage Vₒᵤₜ (also referred to as Vₒ), number of phases N, switching frequency F_{sw}, Vₒᵥᵣₛₕₜ, V_{undrsht}, ΔI_{L-per-phase(pk-pk)}, V_{cap-ripple}, Imax, I_{STEP}, BW, or the like.

The input voltage Vᵢₙ, output voltage Vₒᵤₜ (or Vₒ), number of phases N are described with respect to FIGS. 3A-3B.

The switching frequency F_{sw} is the rate at which the power switches, e.g., power switches FET1, FET2, are turned ON and OFF. A switching cycle of the voltage regulator 300A is determined as 1/F_{sw}. In some embodiments, the switching frequency F_{sw} is a few hundred KHz. This is an example, and other frequency values of F_{sw} are within the scopes of various embodiments.

A voltage overshoot occurs when the voltage at the output OUT exceeds a final steady-state value (e.g., the output voltage Vₒ in accordance with the design specifications) during a transient response. A voltage overshoot is an indicator of how much a voltage regulator's response surpasses the desired output voltage before settling. Vₒᵥᵣₛₕₜ is a voltage overshoot limit set in the design specifications. The voltage regulator 300A is to be configured such that a maximum output voltage during a transient response does not exceed Vₒᵥᵣₛₕₜ. In some embodiments, Vₒᵥᵣₛₕₜ is replaced with a percentage overshoot which is a percentage of the steady-state value.

A voltage undershoot occurs when the voltage at the output OUT falls below the final steady-state value (e.g., the output voltage Vo in accordance with the design specifications) during a transient response. A voltage undershoot is an indicator of how much a voltage regulator's response dips below the desired output voltage before settling. V_{undrsht} is a voltage undershoot limit set in the design specifications. The voltage regulator 300A is to be configured such that a minimum output voltage during a transient response does not dip below V_{undrsht}. In some embodiments, V_{undrsht} is replaced with a percentage undershoot which is a percentage of the steady-state value.

ΔI_{L-per-phase(pk-pk)} refers to a peak-to-peak inductor ripple current per phase. It is the maximum variation (or swing) in an inductor current flowing through an output inductor within a single switching cycle in a voltage regulator. For example, as described with respect to the voltage regulator 300A, ΔI_{L-per-phase(pk-pk)} corresponds to a peak-to-peak swing between a maximum and a minimum of the inductor current I_{L0} when the inductor current I_{L0} rises and falls correspondingly during the ON time of the power switch FET1 and the ON time of the power switch FET2. Similarly, in the voltage regulator 300B, for each phase, e.g., for the first phase corresponding to the voltage regulator circuit 341, ΔI_{L-per-phase(pk-pk)} corresponds to a peak-to-peak swing between a maximum and a minimum of the inductor current I_{L1} when the inductor current ILI rises and falls correspondingly during the ON time of the high-side switch Q11 and ON time of the low-side switch Q12. ΔI_{L-per-phase(pk-pk)} is the maximum limit to the described peak-to-peak swing of the corresponding inductor current.

V_{cap-ripple} is the maximum limit to a peak-peak ripple voltage across the output capacitor C_{O}. This design specifications is used to estimate the minimum capacitance value of the output capacitor C_{O} required to reduce its peak-to-peak ripple voltage below a specified limit, i.e., below V_{cap-ripple}.

Imax is a maximum I_{Load} for which the voltage regulator 300A is configured.

I_{STEP} is the maximum step change in I_{Load} that the voltage regulator 300A is configured to handle. In some embodiments, it is the maximum step change in I_{Load} for which the voltage regulator 300A is configured to work effectively.

BW is the bandwidth of the voltage regulator 300A. As described with respect to FIG. 2E, BW is F₀ which indicates a frequency range over which the voltage regulator 300A is configured to effectively respond to changes in load and/or input conditions. In some embodiments, F₀ is set to F_{sw}/5 or F_{sw}/10. These are examples, and other frequency values of F₀ are within the scopes of various embodiments.

At operations 420, 430 in the process 400, based on the design specifications received at operation 410, parameters of the voltage regulator 300A to be configured are determined.

Specifically, at operation 420, referring to FIG. 3A, based on the received design specifications, a capacitance value of the output capacitor C_{O} and an inductance value of the output inductor L_{O} are determined as parameters of the voltage regulator 300A. For simplicity, unless otherwise specified, capacitance values, inductance values and resistance values of capacitors, inductors and resistors are referred to herein by the same reference numerals of the corresponding capacitors, inductors and resistors.

In some embodiments, the capacitance value C of the output capacitor C_{O} and the inductance value L of the output inductor L_{O} are determined based on the received design specifications, using the following Equations:

$$L = \frac{{V}_{o} ( 1 - D )}{{F}_{sw} Δ {I}_{L - per - phase ( pk - pk )}} \qquad ( 1.1 )$$

$${L}_{EQ} = L / N \qquad ( 1.2 )$$

$${C}_{ripple} = \frac{Δ {I}_{( pk - pk )}}{8 {F}_{sw} {V}_{cap - ripple}} \qquad ( 1.3 )$$

$${C}_{ovrsht} = \frac{{L}_{EQ} {I}_{STEP}^{2}}{2 {V}_{ovrsht} {V}_{o}} \qquad ( 1.4 )$$

$${C}_{undrsht} = \frac{{L}_{EQ} {I}_{STEP}^{2}}{2 {V}_{undrsht} ( {V}_{in} - {V}_{o} ) D} \qquad ( 1.5 )$$

$$C = max ( {C}_{ripple} , {C}_{ovrsht} , {C}_{undrsht} ) \qquad ( 1.6 )$$

$$where$$

$$D = {V}_{o} / {V}_{in} \qquad ( 1.7 )$$

$$Δ {I}_{( pk - pk )} = \frac{{V}_{o}}{L \cdot {F}_{sw}} ( 1 - \frac{m}{N \cdot D} ) \cdot ( 1 + m - N \cdot D ) \qquad ( 1.8 )$$

$$m = floor ( N \cdot D ) \qquad ( 1.9 )$$

In Equation (1.7), D refers to the duty ratio. In Equation (1.8), ΔI₍ₚₖ₋ₚₖ₎ refers to the total peak to peak ripple current through the output capacitor C_{O}. In Equation (1.9), “floor” denotes the floor function.

In some embodiments, the capacitance value C of the output capacitor C_{O} and the inductance value L of the output inductor L_{O} determined in accordance with Equations (1.1), (1.6) are the minimum capacitance value and inductance value required to meet the design specifications. In some embodiments, operation 420 is omitted partly or wholly, e.g., when at least one of the capacitance value C of the output capacitor C_{O} or the inductance value L of the output inductor L_{O} is specified in the design specifications.

At operation 430 in the process 400, referring to FIG. 3A, resistance values and capacitance values of various resistors and capacitors in the compensation network 372 are determined as further parameters of the voltage regulator 300A.

In some embodiments, a resistance value of R_{f1} is selected or predetermined by a human circuit designer, or by a computer system or processor. In at least one embodiment, the resistance value of R_{f1} is selected or predetermined based on the technology and/or materials that will be employed to manufacture the resistors and capacitors in the compensation network 372. In some embodiments, the resistance values and capacitance values of the remaining resistors and capacitors in the compensation network 372 are determined based on Rf and the design specifications, using the following Equations:

$${R}_{c 1} = \frac{{F}_{o} {V}_{saw - tooth} {R}_{f 1}}{{F}_{LC} {V}_{in}} \qquad ( 2.1 )$$

$${R}_{f 3} = \frac{{R}_{f 1}}{\frac{{F}_{sw}}{2 {F}_{LC}} - 1} \qquad ( 2.2 )$$

$${C}_{c 1} = \frac{1}{π {R}_{c 1} {F}_{LC}} \qquad ( 2.3 )$$

$${C}_{c 2} = \frac{1}{2 π {R}_{c 1} {F}_{ESR}} \qquad ( 2.4 )$$

$${C}_{f 3} = \frac{1}{π {R}_{f 3} {F}_{sw}} \qquad ( 2.5 )$$

$$where$$

$${V}_{saw - tooth} = {V}_{ref} / D \qquad ( 2.6 )$$

$${F}_{LC} = \frac{1}{2 π \sqrt{LC}} \qquad ( 2.7 )$$

$${F}_{ESR} = \frac{1}{2 π \cdot ESR \cdot C} \qquad ( 2.8 )$$

Equation (2.6) is an approximation of V_{saw-tooth} which is the amplitude of the saw-tooth voltage V_{OSC} described with respect to FIG. 3A. In some embodiments, the saw-tooth voltage V_{OSC} is generated at same frequency as the switching frequency F_{sw}.

In some embodiments, V_{ref}=Vₒᵤₜ =D×Vᵢₙ for an overall response including both a transient state and a steady state. For a transient state simulation, V_{ref} is set as a grounded connection, i.e., the final voltage value of Vₒᵤₜ will reach zero (meaning transients will gradually die out). In the steady state, V_{ref} is not grounded and the final voltage value of Vₒᵤₜ will reach V_{ref} in the steady state.

F_{LC} in Equation (2.7) and F_{ESR} in Equation (2.8) are also described with respect to FIG. 2E, i.e., F_{LC} is the pole corresponding to L and C, whereas F_{ESR} is the zero caused by the equivalent series resistance (ESR), which is a parasitic resistance value, of the output capacitor C_{O}. In some embodiments, ESR is a predetermined value depending on various factors, including, but not limited to, manufacturing techniques, materials, sizes, or the like.

In some embodiments, as described with respect to FIG. 2E, the resistance values and capacitance values of the resistors and capacitors in the compensation network 372 are selected and/or configured based on Equation (2.1)-(2.5), so as to achieve the desired bandwidth (BW or F₀) and the desired loop gain as illustrated at the example Bode plot 295. In at least one embodiment, the resistance values and capacitance values of the resistors and capacitors in the compensation network 372 as selected and/or configured based on Equation (2.1)-(2.5) further achieve stability for the closed-loop voltage regulator 300A. In some embodiments, stability of a closed-loop system (such as the closed-loop voltage regulator 300A) refers to the ability of the system to maintain its desired performance without exhibiting unbounded or oscillatory behavior over time. In other words, a stable closed-loop system will respond to any input or disturbance by settling to a steady state without diverging or oscillating uncontrollably. In some embodiments, operation 430 is omitted partly or wholly, e.g., when one or more or all of the resistors and capacitors of the compensation network 372 are specified in the design specifications.

At operation 440 in the process 400, model parameters for a linear VR model for the voltage regulator 300A are determined. Example embodiments are described with references to FIGS. 5A-5B.

FIG. 5A is a circuit diagram of a model 500A of a power delivery system 500 including the voltage regulator 300A, in accordance with some embodiments.

The model 500A comprises a network model 560 of an input network, and a schematic model 570 of the voltage regulator 300A. In some embodiments, the input network modeled by the network model 560 corresponds to one or more input networks described with respect to FIGS. 2A-2D. In the example configuration in FIG. 5A, the power delivery system 500 does not include an output network as described with respect to FIGS. 2A-2D, or such output network is ignorable for the purpose of one or more simulations.

The network model 560 comprises a plurality of components which model the input network. In the example configuration in FIG. 5A, the components comprise resistors 561, 564, an inductor 562, and a capacitor 563. The resistor 561 and inductor 562 are coupled in series between the input IN and a positive terminal 511 of a power supply schematically represented by the input voltage Vᵢₙ. The capacitor 563 and resistor 564 are coupled in series between the input IN and the ground (e.g., the node 314). Network model parameters of the network model 560 comprise a resistance value RLin of the resistor 561, an inductance value Lin of the inductor 562, a capacitance value Cin of the capacitor 563, and a resistance value RCin of the resistor 564. In some embodiments, the network model parameters are determined in advance based on various specifics, such as configurations, dimensions, materials, or the like, of the input network. The described configuration of the network model 560 is an example. Other network model configurations are within the scopes of various embodiments.

The schematic model 570 is a VR model of the voltage regulator 300A, and is configured based on one or more of the parameters determined at operations 420, 430, and/or based on one or more of the design specifications provided at operation 410. The schematic model 570 comprises various components described with respect to the voltage regulator 300A. The schematic model 570 further comprises models of the output inductor L_{O} and output capacitor C_{O}.

The output inductor L_{O} is modeled in the schematic model 570 by an inductor L and a resistor DCR. An inductance value of the inductor L is determined at Equation (1.1). The resistor DCR represents a parasitic direct current (DC) resistance value of the output inductor L_{O}, and is determined or estimated in advance based on the physical and electrical configurations of the output inductor L_{O}.

The output capacitor C_{O} is modeled in the schematic model 570 by a capacitor C, a resistor ESR, and an inductor ESL. A capacitance value of the capacitor C is determined at Equations (1.3)-(1.6). The resistor ESR represents a parasitic resistance value of the output capacitor C_{O}. The inductor ESL refers to the equivalent inductance that appears in series with the ideal capacitance (e.g., C) of the output capacitor C_{O} when modeled in an equivalent circuit. In some embodiments, ESR and ESL are predetermined values depending on various factors, including, but not limited to, manufacturing techniques, materials, sizes, configurations, or the like, of the output capacitor C_{O}.

Besides passive elements, such as the described various resistors, capacitors, inductors, which are linear circuit components in simulations, the schematic model 570 still includes active elements or circuits, such as power switches FET1, FET2, drivers DRV1, DRV2, PWM generator 380, error amplifier EA, which are non-linear circuit components in simulations. A simulation executed using the schematic model 570 is potentially time-and/or resource-consuming due to the non-linearity of the schematic model. In some embodiments, the schematic model 570 is further converted to an equivalent model, which is a linear VR model, to reduce the amounts of computing resources and/or time required to complete a simulation of the voltage regulator 300A.

FIG. 5B is a circuit diagram of a model 500B of the power delivery system 500, in accordance with some embodiments.

The model 500B comprises a modified network model 565 of the input network, and an equivalent model 575 of the voltage regulator 300A. The equivalent model 575 is a linear VR model for which model parameters are to be determined.

The modified network model 565 comprises components similar to those of the network model 560. However, the network model parameters of the network model 560 are modified with the duty ratio D of the voltage regulator 300A to become modified network model parameters of the modified network model 565. Specifically, the modified network model parameters in the modified network model 565 comprise a modified resistance value D²×RLin of the resistor 561, a modified inductance value D²×Lin of the inductor 562, a modified capacitance value Cin/D² of the capacitor 563, and a modified resistance value D²×RCin of the resistor 564.

The equivalent model 575 is equivalent to the schematic model 570, and includes no active elements or circuits. In at least one embodiment, the equivalent model 575 is a small signal model usable in an AC simulation, such as the AC simulation 134. In the example configuration in FIG. 5B, the equivalent model 575 is free of non-linear circuit components, such as switches and transistors, and comprises various resistors, capacitors, inductors and a voltage source which are linear circuit components. The error amplifier EA is part of the equivalent model 575. The error amplifier EA is an operational amplifier configured to operate in a linear region and, therefore, the equivalent model 575 remains linear. In some embodiments, the error amplifier EA, i.e., an operational amplifier configured to operate in the linear region, is translated to a SPICE netlist or is integrated in matrix form with the rest of the network, e.g., as described with respect to FIGS. 5C, 5D.

Similar to the schematic model 570, the equivalent model 575 comprises the capacitor C, the resistor ESR, the inductor ESL, and the resistors and capacitors in the compensation network 372. Differences between the equivalent model 575 and the schematic model 570 include a voltage source 571, a resistor 572, an inductor 573, and a resistor Rx. The voltage source 571, resistor 572 and 573 are coupled in series between the input IN and the output OUT. The resistor Rₓ is coupled between the output OUT and the node 320. Resistance values, capacitance values and inductance values of the resistors, capacitors and inductors in the equivalent model 575 constitute model parameters of the equivalent model 575. In some embodiments, a voltage value of the voltage source 571 is also a model parameter of the equivalent model 575.

The resistor 572 replaces the resistor DCR of the schematic model 570. A resistance value of the resistor 572 is determined as (DCR+R_{SW})/N, where R_{SW} is a parasitic resistance value of the power switches FET1, FET2.

The inductor 573 replaces the inductor L of the schematic model 570. An inductance value of the inductor 573 is L_{EQ} determined at Equation (1.2).

The resistor Rₓ corresponds to a parasitic resistance value of the feedback connection 371. In some embodiments, a resistance value of Rx is selected or predetermined by a human circuit designer, or by a computer system or processor. In at least one embodiment, the resistance value of Rx is selected or predetermined based on the configuration and/or material(s) of the feedback connection 371. For example, Rₓ=1uΩ. Other resistance values of Rₓ are within the scopes of various embodiments.

The voltage source 571 has a voltage value determined as v(d)×Vᵢₙ/V_{saw-tooth}, where v(d) is a voltage at a node d coupled to the node 324 which corresponds to the output of the error amplifier EA. In other words, the voltage value of the voltage source 571 corresponds to the voltage v(d). In some embodiments, the voltage source 571 is a voltage dependent voltage source or a voltage controller voltage source (VCVS) which is a voltage source dependent on or controlled by another voltage (i.e., v(d)) in the circuit. In other words, the voltage value of the voltage source 571 depends on the voltage v(d). In some embodiments, the ratio Vᵢₙ/V_{saw-tooth} is a constant and, therefore, the voltage value of the voltage source 571 does not depend on the input voltage Vᵢₙ. In other words, the voltage value of the voltage source 571 is independent from the input voltage Vᵢₙ. In some embodiments, v(d)=Ve.

An upper part of the equivalent model 575 in FIG. 5B, including resistor 572, inductor 573, capacitor C, resistor ESR and inductor ESL, corresponds to an equivalent model of an open-loop voltage regulator, e.g., the voltage regulator 270. A lower part of the equivalent model 575 in FIG. 5B, including the compensation network 372, and the resistor Rx correspond to a feedback connection and a compensator circuit therein, e.g., the feedback connection 271 and compensator circuit 273. In some embodiments, by adding the lower part of the equivalent model 575, the resistor Rx and the voltage source 571 associated with the feedback connection to the upper part, it is possible to convert an open-loop voltage regulator to a closed-loop voltage regulator, as described with respect to FIGS. 2C-2D. In at least one embodiment, the upper part (i.e., an equivalent model of an open-loop voltage regulator) is existing or pre-configured. By simply adding the lower part (i.e., a compensation network) and the resistor Rₓ to the existing or pre-configured upper part, it is possibly to quickly obtain the equivalent model 575 of the closed-loop voltage regulator 300A. In some embodiments, the configuration and/or more parameters of the compensation network are variable and/or customizable which permits a quick and/or easy re-configuration of the resulting closed-loop voltage regulator to meet the design specifications and/or one or more further design considerations.

The model 500B further comprises a plurality of nodes which are used to define or describe the model 500B, and/or of which voltages and/or currents are determined in one or more simulations. For example, the modified network model 565 comprises a node j, and a node j+1. The resistor 561 is coupled between node j and node j+1. The inductor 562 is coupled between node j+1 and input IN. In the example configuration in FIG. 5B, the ellipsis (i.e., “. . . ”) indicates that, in one or more embodiments, the modified network model 565 includes one or more further nodes with one or more further passive elements, such as resistors, capacitors and/or inductors. As described, the described and shown configuration of the modified network model 565 is an example, and other network model configurations are within the scopes of various embodiments.

The equivalent model 575 comprises a node M between the inductor ESL and the capacitor C, a node M+1 between the capacitor C and the resistor ESR, and a node M+2 corresponding to the output OUT. The compensation network 372 further comprises nodes k, k+1, k+2, k+3, k+4, k+5 corresponding to nodes 320-324 and the non-inverting input of the error amplifier EA.

In some embodiments, a voltage and/or a current at one or more nodes of the model 500B is/are predetermined or set as inputs or starting conditions for a simulation. For example, the reference voltage V_{ref} at node k+5 is predetermined and serves as an input for a simulation. As described herein, for a transient state simulation, V_{ref} is set as the ground voltage as exemplarity shown in FIG. 5B, whereas for a steady state simulation or for an overall response simulation, V_{ref}=Vₒᵤₜ=D×Vᵢₙ.

In some embodiments, results of one or more simulations include voltages and/or currents at one or more nodes of the model 500B. For example, results of a simulation of the equivalent model 575 of the voltage regulator 300A alone, or results of a simulation of the model 500B including both the equivalent model 575 and the modified network model 565, include voltages at nodes k, k+1, k+2, k+3, k+4 and a current I_{OA} at node k+4 corresponding to the output of the error amplifier EA.

At operation 450 in the process 400, the model parameters of the linear VR model, i.e., the equivalent model 575, are incorporated in a netlist or in at least one matrix for a Modified Nodal Analysis (MNA).

In at least one embodiment, the model parameters of the equivalent model 575 are incorporated in a netlist which is used in one or more simulations using, e.g., software such as SPICE. In some embodiments, the parameters of the equivalent model 575 are incorporated in one or more MNA matrices, examples of which are described herein with references to FIGS. 5C-5D.

FIG. 5C is a schematic view of a portion of a conductance matrix 500C for MNA, in accordance with some embodiments.

The portion of the conductance matrix 500C in FIG. 5C is presented, for the illustration purposes, in the form of a crosstable 580 having a plurality of rows 581 and a plurality of columns 582. Each of the rows 581 corresponds to a node among nodes j. . . . M+1, M+2, k, k+1, k+2, k+3, k+4, k+5 of the model 500B as described with respect to FIG. 5B. Each of the columns 582 corresponds to a node among nodes j. . . . M+1, M+2, k, k+1, k+2, k+3, k+4, k+5 of the model 500B. For simplicity, not all nodes of the model 500B are illustrated in FIG. 5C.

At an intersection of a row 581 and a column 582 of the crosstable 580, a conductance value of a node, or a connection or link between two nodes, is provided. For example, for an intersection 583 corresponding to node k, a conductance value of node k is given as (1/R_{f1}+1/R_{f3}+1/Rₓ) which corresponds to all resistors R_{f1}, R_{f3} and Rₓ directly coupled to node k, as illustrated in FIG. 5B. For another example, for an intersection 584 corresponding to the connection between node k and node k+2, a conductance value of the connection is given as (−1/R_{f1}) which corresponds to the resistor Rf directly coupled to and between node k and node k+2, as illustrated in FIG. 5B. A conductance value of 0 (zero), e.g., at an intersection 585, indicates that there is no resistor directly coupled to and between the corresponding nodes k and k+4. A conductance value of 1 (one), e.g., at an intersection 586, indicates that the corresponding nodes k+5 and k+4 are directly coupled to each other, without a resistor in between.

A section 587 of the crosstable 580 contains compensation network information corresponding to nodes k, k+1, k+2, k+3, k+4, k+5, and conductance values associated with nodes k, k+1, k+2, k+3, k+4, k+5. The compensation network information in the section 587 corresponds to the compensation network 372 described with respect to FIG. 5B. In some embodiments, information in the crosstable 580 and outside the section 587 is included in an existing or preconfigured MNA conductance matrix, and corresponds to at least an equivalent model of an open-loop voltage regulator. In at least one embodiment, by simply adding compensation network information (e.g., the section 587) to the existing or preconfigured MNA conductance matrix, it is possible to modify the existing or preconfigured MNA conductance matrix to obtain the conductance matrix 500C in which the open-loop voltage regulator of the existing or preconfigured MNA conductance matrix is converted to a closed-loop voltage regulator, as described with respect to the upper part and lower part of FIG. 5B.

FIG. 5D is a schematic view of a portion of a capacitance matrix 500D for MNA, in accordance with some embodiments.

The portion of the capacitance matrix 500D in FIG. 5D is presented, for the illustration purposes, in the form of a crosstable 590 which is configured similar to the crosstable 580, and has a plurality of rows and a plurality of columns. Each of the rows corresponds to a node among nodes j. . . . M+1, M+2, k, k+1, k+2, k+3, k+4, k+5 of the model 500B as described with respect to FIG. 5B. Each of the columns corresponds to a node among nodes j. . . . M+1, M+2, k, k+1, k+2, k+3, k+4, k+5 of the model 500B. For simplicity, not all nodes of the model 500B are illustrated in FIG. 5D.

At an intersection of a row and a column of the crosstable 590, a capacitance value of a node, or a connection or link between two nodes, is provided. For example, for an intersection 593 corresponding to node k+2, a capacitance value of node k+2 is given as (C_{c2}+C_{f3}) which corresponds to all capacitors C_{c2} and C_{f3} directly coupled to node k+2, as illustrated in FIG. 5B. For another example, for an intersection 594 corresponding to the connection between node k+4 and node k+2, a capacitance value of the connection is given as (−C_{c2}) which corresponds to the capacitor C_{c2} directly coupled to and between node k+4 and node k+2, as illustrated in FIG. 5B. A capacitance value of 0 (zero), e.g., at an intersection 595, indicates that there is no capacitor directly coupled to and between the corresponding nodes k and k+2.

A section 597 of the crosstable 590 contains compensation network information corresponding to nodes k, k+1, k+2, k+3, k+4, k+5, and capacitance values associated with nodes k, k+1, k+2, k+3, k+4, k+5. The compensation network information in the section 597 corresponds to the compensation network 372 described with respect to FIG. 5B. In some embodiments, information in the crosstable 590 and outside the section 597 is included in an existing or preconfigured MNA capacitance matrix, and corresponds to at least an equivalent model of an open-loop voltage regulator. In at least one embodiment, by simply adding compensation network information (e.g., the section 597) to the existing or preconfigured MNA capacitance matrix, it is possible to modify the existing or preconfigured MNA capacitance matrix to obtain the capacitance matrix 500D in which the open-loop voltage regulator of the existing or preconfigured MNA capacitance matrix is converted to a closed-loop voltage regulator, as described with respect to the upper part and lower part of FIG. 5B.

In some embodiments, compensation network information similar to that described with respect to the section 587 of the conductance matrix 500C and the section 597 of the capacitance matrix 500D is added to a netlist to be used next in one or more simulations. In at least one embodiment, a quick and simple conversion (or expansion) of an existing netlist containing information of an open-loop voltage regulator into a netlist containing information of a closed-loop voltage regulator, by adding compensation network information, is achievable in a similar manner to that described with respect to the conductance matrix 500C and capacitance matrix 500D.

At operation 460 in the process 400, the netlist or the at least one MNA matrix including the model parameters of the equivalent model 575 is used in one or more simulations in a pre-layout verification operation.

In some embodiments, one or more of a transient simulation 462, an AC simulation 464, and a power efficiency verification 466 are performed at operation 460. In at least one embodiment, the transient simulation 462 and AC simulation 464 correspond to the transient simulation 132 and AC simulation 134, as described with respect to FIG. 1. A simulation or MNA using the conductance matrix 500C and the capacitance matrix 500D provides simulation results which include voltages and/or currents at various nodes of the model 500B. A portion 589 of the simulation results is schematically shown in FIGS. 5C-5D, and includes voltages Vk, Vk+1, Vk+2, Vk+3, Vk+4 of corresponding nodes k, k+1, k+2, k+3, k+4, and current I_{OA} at node k+4 as described with respect to FIG. 5B. Similar simulation results are obtainable in one or more embodiments where simulations are performed using a netlist as described herein.

In some embodiments, the power efficiency verification 466 corresponds to the power efficiency verification 136, as described with respect to FIG. 1. In at least one embodiment, power efficiency is determined as a ratio of P_{Load}/Pᵢₙ=P_{Load}/(P_{Load}+P_{Loss}), where Pᵢₙ is the total power received from the power supply, P_{Load} is the useful power delivered to or consumed by the load, and P_{Loss} is the loss in the power delivery system. P_{Loss} includes one or more components such as losses due to switching of the drivers DRV1, DRV2, the ON resistance of the power switches FET1, FET2, and/or parasitic resistances of the output inductor L_{O} and/or output capacitor C_{O}. Each of P_{Load}, P_{Loss} and/or components thereof is determined or estimated based on voltages and/or currents at various nodes in the simulation results.

In at least one embodiment, the calculated power efficiency is compared with a predetermined threshold to determine whether the voltage regulator being designed and/or the power delivery system containing the voltage regulator is sufficiently efficient. In at least one embodiment, the simulation results are evaluated in various aspects and/or merits to determine whether one or more predetermined specifications and/or requirements are met by the voltage regulator and/or the power delivery system containing the voltage regulator.

If one or more specifications and/or requirements and/or power efficiency are not met, the IC design and/or the power delivery system and/or the voltage regulator is/are redesigned or re-configured. In at least one embodiment, one or more parameters of the voltage regulator are adjusted. For example, one or more of the inductance value of the output inductor L_{O}, the capacitance value of the output capacitor C_{O}, the switching frequency F_{sw}, or the like is/are adjusted. Thereafter, one or more of operations 420-450 are performed to update the equivalent model of the voltage regulator being designed, and one or more simulations or verifications of operation 460 are re-executed using the updated equivalent model to verify whether the adjustments have resulted in all specifications and/or requirements being met. In some embodiments, the described process is repeated one or more times until it is determined that the designed voltage regulator is acceptable, or it is determined that the voltage regulator despite the modifications/adjustments does not satisfy all requirements and needs to be redesigned/re-configured.

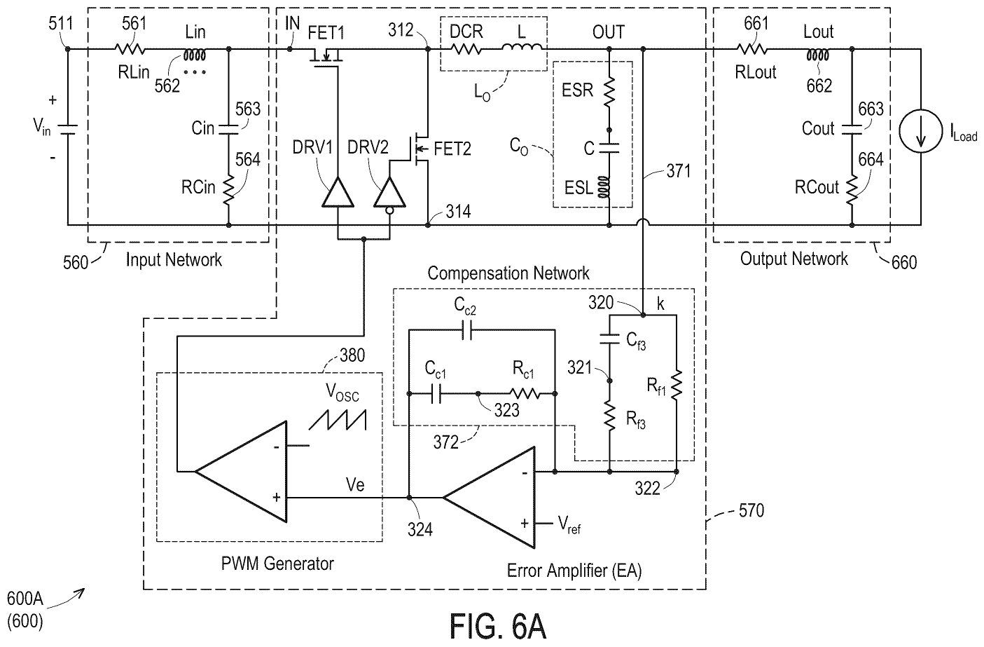

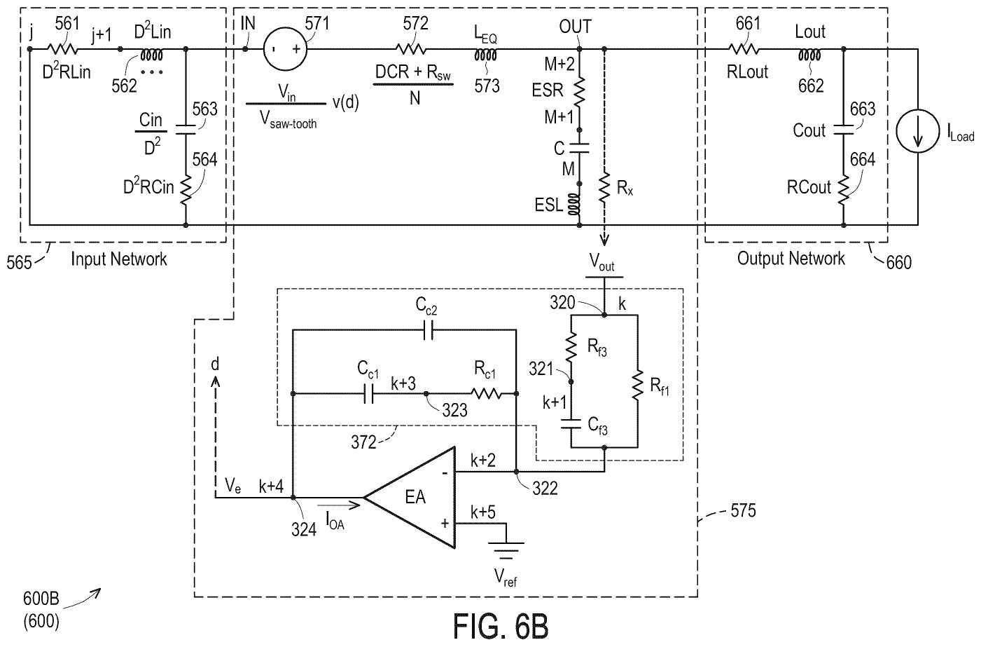

FIGS. 6A, 6B are circuit diagrams of models 600A, 600B of a power delivery system 600 including a voltage regulator, in accordance with some embodiments. In some embodiments, the voltage regulator and/or the power delivery system 600 described with respect to FIGS. 6A-6B correspond to one or more voltage regulators and/or one or more power delivery systems described with respect to one or more of FIGS. 1, 2A-2E, 3A-3B. Corresponding components in FIGS. 2E, 3A-3B, 5A-5B, 6A-6B are designated by the same reference numerals. In example embodiments described herein with references to FIGS. 6A-6B, the voltage regulator is to be configured, modeled and verified in the process 400 of FIG. 4 and corresponds to the voltage regulator 300A and/or voltage regulator 300B. For simplicity, the voltage regulator 300A is referred to in the following description of the example embodiments. The described example embodiments are also applicable to the voltage regulator 300B.

In FIG. 6A, the power delivery system 600 is similar to the power delivery system 500, but differs from the power delivery system 500 in that the power delivery system 600 additionally includes an output network. Therefore, the model 600A is similar to the model 500A, but differs from the model 500A in that the model 600A additionally comprises a network model 660 of the output network. In some embodiments, the output network modeled by the network model 660 corresponds to one or more output networks described with respect to FIGS. 2A-2D.

The network model 660 comprises a plurality of components which model the output network. In the example configuration in FIG. 6A, the components comprise resistors 661, 664, an inductor 662, and a capacitor 663. The resistor 661 and inductor 662 are coupled in series between the output OUT and a positive terminal 611 of the load schematically represented by I_{Load}. The capacitor 663 and resistor 664 are coupled in series between the output OUT and the ground (e.g., the node 314). Network model parameters of the network model 660 comprise a resistance value RLout of the resistor 661, an inductance value Lout of the inductor 662, a capacitance value Cout of the capacitor 663, and a resistance value RCout of the resistor 664. In some embodiments, the network model parameters are determined in advance based on various specifics, such as configurations, dimensions, materials, or the like, of the output network. The described configuration of the network model 660 is an example. Other network model configurations are within the scopes of various embodiments.

In FIG. 6B, the model 600B is similar to the model 500B, but differs from the model 500B in that the model 600B additionally comprises the network model 660 of the output network. In some embodiments, the model 600B is configured at operation 440, and/or integrated into a netlist or at least one MNA matrix at operation 450, and/or used for one or more simulations and/or verifications at operation 460.

In the example configurations in FIGS. 5A-5B, 6A-6B, the power delivery systems 500, 600 include input networks. In at least one embodiment (not shown), a power delivery system includes a voltage regulator as described but without an input network, or such input network is ignorable for the purpose of one or more simulations.

In the example configurations in FIGS. 5A-5B, 6A-6B, the power delivery systems 500, 600 include closed-loop voltage regulators. In at least one embodiment (not shown), a power delivery system includes an open-loop voltage regulator and a linear VR model of such an open-loop voltage regulator is used for one or more simulations in a pre-layout verification operation. An example of a linear VR model of an open-loop voltage regulator in accordance with some embodiments is described herein with respect to the upper part of the equivalent model 575.

In some other approaches, to verify an IVR's performance and/or system power integrity after inducing the IVR, a simulation of the IVR, or a circuit including the IVR, requires a non-linear model of the IVR due to power switches and control circuits inside the IVR. Such a simulation is time-consuming and/or requires a significant amount of computing resources. Further, in accordance with other approaches, there is no method available to perform an AC analysis that accounts for parasitics from an input network, through a closed-loop voltage regulator, to an output network of the voltage regulator. It is, therefore, difficult to obtain information to understand weaknesses of the closed-loop voltage regulator, or a system including the voltage regulator, in the frequency spectrum.

In some embodiments, voltage regulator circuitry is replaced with a macro model, to make feasible an AC analysis, or a co-simulation, of the overall power delivery system including a closed-loop voltage regulator and at least one of an input network or an output network, while improving the co-simulation time from days as in the other approaches to minutes.

In some embodiments, the voltage regulator macro modeling approximates electrical characteristics of voltage regulator circuitry from the time and frequency domain points of view, given the design specifications such as maximum current load, maximum allowable voltage swings, closed loop bandwidth, or the like.

In at least one embodiment, a linear VR model is used to represent the electrical characteristics of a closed-loop multi-phase voltage regulator, which avoids simulations with non-linear models or non-linear circuit components, thereby reducing the simulation time significantly.

In one or more embodiments, it is possible to incorporate the linear VR model of a closed-loop voltage regulator into a netlist or an MNA, together with network models which include passive elements that model or represent parasitics from an input network of the closed-loop voltage regulator, through the closed-loop voltage regulator, to an output network of the closed-loop voltage regulator. As a result, an AC analysis of the overall power delivery system powered by the closed-loop VR becomes feasible, in one or more embodiments.

In one or more embodiments, it is possible and simple to convert an existing netlist or MNA matrix already containing a VR model of an open-loop voltage regulator into a netlist or MNA matrix containing a VR model of a closed-loop voltage regulator, by adding compensation network information to the existing netlist or MNA matrix.

In some embodiments, a standard interface is provided in a power integrity (PI) analysis that frees system designers from needing circuitry details. In an example, the interface is configured to receive design specifications from, or upon request of, a system designer. A computer system or processor is coupled to the interface to receive the design specifications, and is configured to automatically determine parameters of a voltage regulator to be designed, generate a linear VR model for the voltage regulator, and execute one or more simulations using the linear VR model. In at least one embodiment, the computer system or processor is configured to provide an evaluation or assessment of whether the voltage regulator and/or the overall power delivery system satisfy predetermined specifications and/or requirements. In at least one embodiment, the computer system or processor is configured to automatically make adjustments to the configuration of the voltage regulator and/or the power delivery system in response to an assessment that voltage regulator and/or the overall power delivery system as currently configured does not satisfy one or more predetermined specifications and/or requirements. In at least one embodiment, the computer system or processor is configured to automatically perform the described process from receipt of the design specifications to output of the final assessment and/or to output of an acceptable configuration of the voltage regulator and/or the power delivery system, without requiring input from the system designer while freeing the system designer from needing circuitry details.

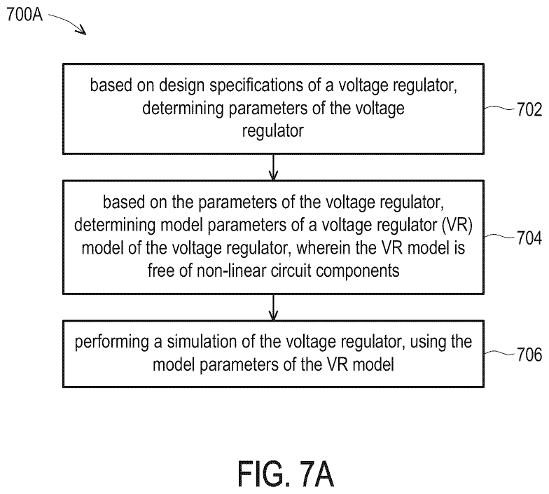

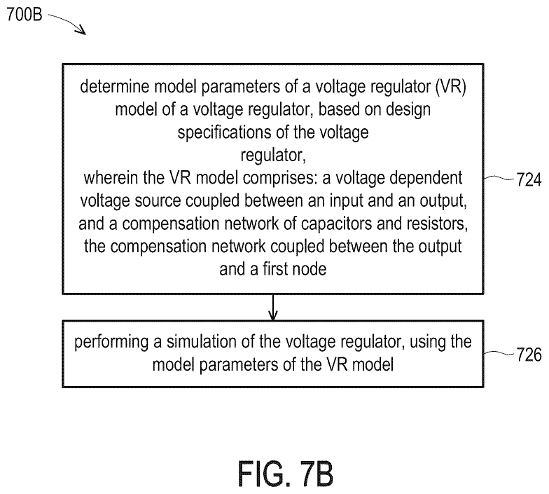

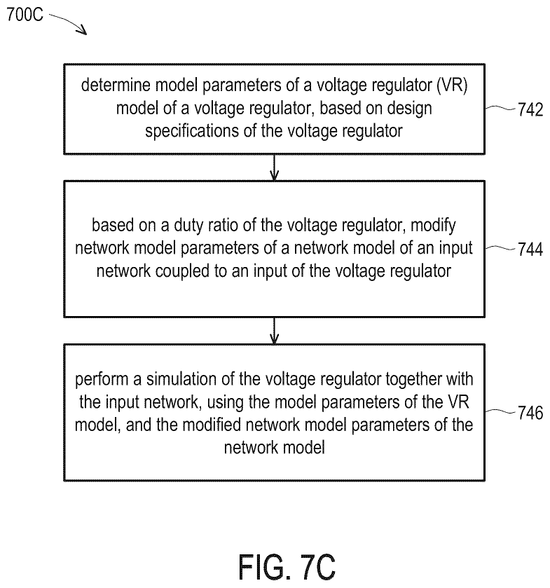

FIG. 7A is a flowchart of a process 700A, in accordance with some embodiments. In some embodiments, the process 700A is performed at least partially by a computer system or a processor, as described herein. The process 700A comprises operations 702, 704, 706.

At operation 702, based on design specifications of a voltage regulator, parameters of the voltage regulator are determined. For example, as described with respect to operations 420, 430 of the process 400, based on the design specifications of a voltage regulator provided at operation 410, various parameters of a voltage regulator are determined. Referring to FIG. 3A, example voltage regulator parameters include, but are not limited to, one or more of an inductance value L of an output inductor L_{O}, a capacitance value C of an output capacitor C_{O}, one or more capacitance values of one or more capacitors in a compensation network 372, one or more resistance values of one or more resistors in the compensation network 372, or the like.

At operation 704, based on the parameters of the voltage regulator, model parameters of a voltage regulator (VR) model of the voltage regulator are determined, wherein the VR model is free of non-linear circuit components. For example, as described with respect to operation 440 of the process 400, model parameters of a VR model, e.g., an equivalent model 575 described with respect to FIG. 5B, are determined. The equivalent model 575 is free of non-linear circuit components, i.e., free of transistors, switches and circuits containing transistors and/or switches, such as power switches, drivers, control circuits, comparators, or the like. The equivalent model 575 includes linear circuit components, such as resistors, capacitors, inductors, voltage source. In the example configuration in FIG. 5B, model parameters to be determined for the equivalent model 575 include, but are not limited to, one or more of a resistance value of a resistor 572, an inductance value of an inductor 573, a resistance value of a resistor Rx, a capacitance value of a capacitor C, a resistance value of a resistor ESR, an inductance value of an inductor ESL, one or more capacitance values of one or more capacitors in the compensation network 372, one or more resistance values of one or more resistors in the compensation network 372, or the like.

At operation 706, a simulation of the voltage regulator is performed, using the model parameters of the VR model. For example, as described with respect to operation 460 of the process 400, one or more simulations and/or verifications are performed using the equivalent model 575 the model parameters of which are obtained at operation 440. In some embodiments, the model parameters of the equivalent model 575 are included in one or more MNA matrices as described with respect to FIGS. 5C-5D, or in a netlist as described herein. In at least one embodiment, one or more advantages described herein are achievable by the process 700A, e.g., the simulation time and/or computing resources are reduced in one or more embodiments.

FIG. 7B is a flowchart of a process 700B, in accordance with some embodiments. In some embodiments, the process 700B is performed at least partially by a computer system or a processor, as described herein. The process 700B comprises operations 724, 726.

At operation 724, based on design specifications of a voltage regulator, model parameters of a voltage regulator (VR) model of the voltage regulator are determined. The VR model comprises: a voltage dependent voltage source coupled between an input and an output, and a compensation network of capacitors and resistors coupled between the output and a first node. For example, as described with respect to FIG. 5B, a VR model, i.e., the equivalent model 575, comprises a voltage dependent voltage source 571 coupled between an input IN and an output OUT. The equivalent model 575 further comprises a compensation network 372 of capacitors and resistors coupled between the output OUT and a first node 324. Various model parameters of the equivalent model 575 are determined, for example, in a manner similar to that described with respect to one or more of operations 702, 704 of the process 700A. Example model parameters of the equivalent model 575 include, but are not limited to, one or more of resistance values R_{f1}, R_{f3}, R_{c1}, capacitance values C_{c1}, C_{c2}, C_{f3}, and a voltage value of the voltage dependent voltage source 571 which depends on a voltage value v(d).

At operation 726, a simulation of the voltage regulator is performed, using the model parameters of the VR model, for example, in a manner similar to that described with respect to operation 706 of the process 700A. In at least one embodiment, one or more advantages described herein are achievable by the process 700B, e.g., the simulation time and/or computing resources are reduced in one or more embodiments.

FIG. 7C is a flowchart of a process 700C, in accordance with some embodiments. In some embodiments, the process 700C is performed at least partially by a computer system or a processor, as described herein. The process 700C comprises operations 742, 744, 746.

At operation 742, based on design specifications of a voltage regulator, model parameters of a voltage regulator (VR) model of the voltage regulator are determined, for example, in a manner similar to that described with respect to one or more of operations 702, 704 of the process 700A.

At operation 744, based on a duty ratio of the voltage regulator, network model parameters of a network model of an input network coupled to an input of the voltage regulator are modified. For example, as described with respect to FIGS. 5A, 5B, network model parameters associated with resistors 561, 564, capacitor 563, inductor 562 of a network model 560 of an input network, as exemplarily shown in FIG. 5A, are modified based on the duty ratio D of the voltage regulator. As a result, modified network model parameters of a modified network model 565 are obtained, as exemplarily shown in FIG. 5B.

At operation 746, a simulation of the voltage regulator together with the input network is performed, using the model parameters of the VR model, and the modified network model parameters of the network model. For example, as described with respect to operation 460 of the process 400, a co-simulation of an overall power delivery system 500 including the voltage regulator represented by the equivalent model 575 in FIG. 5B and at least the input network represented by the modified network model 565 in FIG. 5B is performed. The co-simulation uses model parameters of the equivalent model 575 and the modified network model parameters of the modified network model 565. In some embodiments, the model parameters of the equivalent model 575 and the modified network model parameters of the modified network model 565 are included in one or more MNA matrices as described with respect to FIGS. 5C-5D, or in a netlist as described herein. In at least one embodiment, one or more advantages described herein are achievable by the process 700C, e.g., the simulation time and/or computing resources are reduced in one or more embodiments.

The described methods include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

In some embodiments, at least one method(s) discussed above is performed in whole or in part by at least one EDA system. In some embodiments, an EDA system is usable as part of a design house of an IC manufacturing system discussed below.

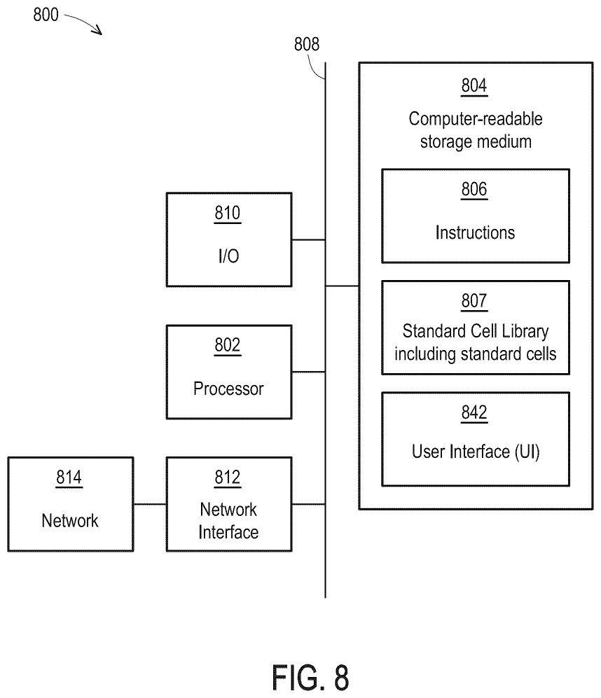

FIG. 8 is a block diagram of an electronic design automation (EDA) system 800 in accordance with some embodiments.

In some embodiments, EDA system 800 includes an APR system. Methods described herein of designing layout diagrams represent wire routing arrangements, in accordance with one or more embodiments, are implementable, for example, using EDA system 800, in accordance with some embodiments.

In some embodiments, EDA system 800 is a general purpose computing device including a hardware processor 802 and a non-transitory, computer-readable storage medium 804. Storage medium 804, amongst other things, is encoded with, i.e., stores, computer program code 806, i.e., a set of executable instructions. Execution of instructions 806 by hardware processor 802 represents (at least in part) an EDA tool which implements a portion or all of the methods described herein in accordance with one or more embodiments (hereinafter, the noted processes and/or methods).

Processor 802 is electrically coupled to computer-readable storage medium 804 via a bus 808. Processor 802 is also electrically coupled to an I/O interface 810 by bus 808. A network interface 812 is also electrically connected to processor 802 via bus 808. Network interface 812 is connected to a network 814, so that processor 802 and computer-readable storage medium 804 are capable of connecting to external elements via network 814. Processor 802 is configured to execute computer program code 806 encoded in computer-readable storage medium 804 in order to cause system 800 to be usable for performing a portion or all of the noted processes and/or methods. In one or more embodiments, processor 802 is a central processing unit (CPU), a multi-processor, a distributed processing system, an application specific integrated circuit (ASIC), and/or a suitable processing unit.

In one or more embodiments, computer-readable storage medium 804 is an electronic, magnetic, optical, electromagnetic, infrared, and/or a semiconductor system (or apparatus or device). For example, computer-readable storage medium 804 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 804 includes a compact disk-read only memory (CD-ROM), a compact disk-read/write (CD-R/W), and/or a digital video disc (DVD).

In one or more embodiments, storage medium 804 stores computer program code 806 configured to cause system 800 (where such execution represents (at least in part) the EDA tool) to be usable for performing a portion or all of the noted processes and/or methods. In one or more embodiments, storage medium 804 also stores information which facilitates performing a portion or all of the noted processes and/or methods. In one or more embodiments, storage medium 804 stores library 807 of standard cells including such standard cells as disclosed herein.

EDA system 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

EDA system 800 also includes network interface 812 coupled to processor 802. Network interface 812 allows system 800 to communicate with network 814, to which one or more other computer systems are connected. Network interface 812 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 800.

System 800 is configured to receive information through I/O interface 810. The information received through I/O interface 810 includes one or more of instructions, data, design rules, libraries of standard cells, and/or other parameters for processing by processor 802. The information is transferred to processor 802 via bus 808. EDA system 800 is configured to receive information related to a UI through I/O interface 810. The information is stored in computer-readable medium 804 as user interface (UI) 842.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 800. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable storage medium. Examples of a non-transitory computer readable storage medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

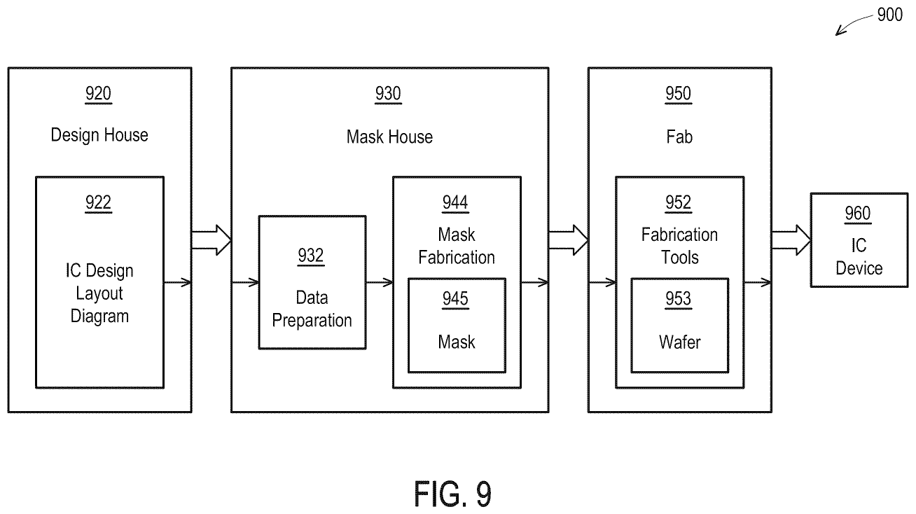

FIG. 9 is a block diagram of an integrated circuit (IC) manufacturing system 900, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 900.

In FIG. 9, IC manufacturing system 900 includes entities, such as a design house 920, a mask house 930, and an IC manufacturer/fabricator (“fab ”) 950, that interact with one another in the design, development, and manufacturing cycles and/or services related to manufacturing an IC device 960. The entities in system 900 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 920, mask house 930, and IC fab 950 is owned by a single larger company. In some embodiments, two or more of design house 920, mask house 930, and IC fab 950 coexist in a common facility and use common resources.

Design house (or design team) 920 generates an IC design layout diagram 922. IC design layout diagram 922 includes various geometrical patterns designed for an IC device 960. The geometrical patterns correspond to patterns of metal, oxide, or semiconductor layers that make up the various components of IC device 960 to be fabricated. The various layers combine to form various IC features. For example, a portion of IC design layout diagram 922 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 920 implements a proper design procedure to form IC design layout diagram 922. The design procedure includes one or more of logic design, physical design or place-and-route operation. IC design layout diagram 922 is presented in one or more data files having information of the geometrical patterns. For example, IC design layout diagram 922 can be expressed in a GDSII file format or DFII file format.

Mask house 930 includes data preparation 932 and mask fabrication 944. Mask house 930 uses IC design layout diagram 922 to manufacture one or more masks 945 to be used for fabricating the various layers of IC device 960 according to IC design layout diagram 922. Mask house 930 performs mask data preparation 932, where IC design layout diagram 922 is translated into a representative data file (“RDF”). Mask data preparation 932 provides the RDF to mask fabrication 944. Mask fabrication 944 includes a mask writer. A mask writer converts the RDF to an image on a substrate, such as a mask (reticle) 945 or a semiconductor wafer 953. The design layout diagram 922 is manipulated by mask data preparation 932 to comply with particular characteristics of the mask writer and/or requirements of IC fab 950. In FIG. 9, mask data preparation 932 and mask fabrication 944 are illustrated as separate elements. In some embodiments, mask data preparation 932 and mask fabrication 944 can be collectively referred to as mask data preparation.

In some embodiments, mask data preparation 932 includes optical proximity correction (OPC) which uses lithography enhancement techniques to compensate for image errors, such as those that can arise from diffraction, interference, other process effects and the like. OPC adjusts IC design layout diagram 922. In some embodiments, mask data preparation 932 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 932 includes a mask rule checker (MRC) that checks the IC design layout diagram 922 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 922 to compensate for limitations during mask fabrication 944, which may undo part of the modifications performed by OPC in order to meet mask creation rules.

In some embodiments, mask data preparation 932 includes lithography process checking (LPC) that simulates processing that will be implemented by IC fab 950 to fabricate IC device 960. LPC simulates this processing based on IC design layout diagram 922 to create a simulated manufactured device, such as IC device 960. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 922.

It should be understood that the above description of mask data preparation 932 has been simplified for the purposes of clarity. In some embodiments, data preparation 932 includes additional features such as a logic operation (LOP) to modify the IC design layout diagram 922 according to manufacturing rules. Additionally, the processes applied to IC design layout diagram 922 during data preparation 932 may be executed in a variety of different orders.

After mask data preparation 932 and during mask fabrication 944, a mask 945 or a group of masks 945 are fabricated based on the modified IC design layout diagram 922. In some embodiments, mask fabrication 944 includes performing one or more lithographic exposures based on IC design layout diagram 922. In some embodiments, an electron-beam (e-beam) or a mechanism of multiple e-beams is used to form a pattern on a mask (photomask or reticle) 945 based on the modified IC design layout diagram 922. Mask 945 can be formed in various technologies. In some embodiments, mask 945 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 945 includes a transparent substrate (e.g., fused quartz) and an opaque material (e.g., chromium) coated in the opaque regions of the binary mask. In another example, mask 945 is formed using a phase shift technology. In a phase shift mask (PSM) version of mask 945, various features in the pattern formed on the phase shift mask are configured to have proper phase difference to enhance the resolution and imaging quality. In various examples, the phase shift mask can be attenuated PSM or alternating PSM. The mask(s) generated by mask fabrication 944 is used in a variety of processes. For example, such a mask(s) is used in an ion implantation process to form various doped regions in semiconductor wafer 953, in an etching process to form various etching regions in semiconductor wafer 953, and/or in other suitable processes.

IC fab 950 is an IC fabrication business that includes one or more manufacturing facilities for the fabrication of a variety of different IC products. In some embodiments, IC Fab 950 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 950 includes fabrication tools 952 configured to execute various manufacturing operations on semiconductor wafer 953 such that IC device 960 is fabricated in accordance with the mask(s), e.g., mask 945. In various embodiments, fabrication tools 952 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 950 uses mask(s) 945 fabricated by mask house 930 to fabricate IC device 960. Thus, IC fab 950 at least indirectly uses IC design layout diagram 922 to fabricate IC device 960. In some embodiments, semiconductor wafer 953 is fabricated by IC fab 950 using mask(s) 945 to form IC device 960. In some embodiments, the IC fabrication includes performing one or more lithographic exposures based at least indirectly on IC design layout diagram 922. Semiconductor wafer 953 includes a silicon substrate or other proper substrate having material layers formed thereon. Semiconductor wafer 953 further includes one or more of various doped regions, dielectric features, multilevel interconnects, and the like (formed at subsequent manufacturing steps).

In some embodiments, a method is performed at least partially by a processor and comprises, based on design specifications of a voltage regulator, determining parameters of the voltage regulator. The method further comprises, based on the parameters of the voltage regulator, determining model parameters of a voltage regulator (VR) model of the voltage regulator. The method further comprises performing a simulation of the voltage regulator, using the model parameters of the VR model. The VR model comprises a voltage source coupled between an input and an output, and a compensation network of capacitors and resistors. The compensation network is coupled between the output and a first node. The model parameters of the VR model comprise a voltage value of the voltage source which corresponds to a voltage value at the first node.

In some embodiments, a system comprises a processor configured to determine model parameters of a voltage regulator (VR) model of a voltage regulator based on design specifications of the voltage regulator, and perform a simulation of the voltage regulator using the model parameters of the VR model. The VR model comprises a voltage source coupled between an input of the voltage regulator and an output of the voltage regulator, and a compensation network of capacitors and resistors. The compensation network is coupled between the output and a first node. The model parameters of the VR model comprise resistance values of the resistors in the compensation network, capacitance values of the capacitors in the compensation network, and a voltage value of the voltage source. The voltage value does not depend on an input voltage at the input of the voltage regulator.

In some embodiments, a computer program product comprises a non-transitory, computer-readable storage medium containing therein instructions. The instructions are executable by a processor to cause the processor to determine model parameters of a voltage regulator (VR) model of a voltage regulator, based on design specifications of the voltage regulator. The VR model comprises a compensation network of capacitors and resistors. The instructions are executable to further cause the processor to modify a conductance matrix of a modified nodal analysis (MNA), by adding a plurality of nodes in the compensation network and conductance values associated with the plurality of nodes to the conductance matrix. The conductance values associated with the plurality of nodes correspond to resistance values of the resistors in the compensation network. The instructions are executable to further cause the processor to modify a capacitance matrix of the MNA, by adding the plurality of nodes and capacitance values of the capacitors in the compensation network to the capacitance matrix. The instructions are executable to further cause the processor to perform a simulation of the voltage regulator. The simulation comprises the MNA using the modified conductance matrix and the modified capacitance matrix.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, the method performed at least partially by a processor and comprising:
based on design specifications of a voltage regulator, determining parameters of the voltage regulator;
based on the parameters of the voltage regulator, determining model parameters of a voltage regulator (VR) model of the voltage regulator; and
performing a simulation of the voltage regulator, using the model parameters of the VR model,
wherein
the VR model comprises:
a voltage source coupled between an input and an output, and
a compensation network of capacitors and resistors, the compensation network coupled between the output and a first node, and
the model parameters of the VR model comprise:
a voltage value of the voltage source which corresponds to a voltage value at the first node.

2. The method of claim 1, wherein
the model parameters of the VR model further comprise:
resistance values of the resistors in the compensation network, and
capacitance values of the capacitors in the compensation network.

3. The method of claim 2, further comprising:
modifying a conductance matrix of a modified nodal analysis (MNA), by adding a plurality of nodes in the compensation network and conductance values associated with the plurality of nodes to the conductance matrix, the plurality of nodes comprising the first node, the conductance values associated with the plurality of nodes correspond to the resistance values of the resistors in the compensation network; and
modifying a capacitance matrix of the MNA, by adding the plurality of nodes and the capacitance values of the capacitors in the compensation network to the capacitance matrix,
wherein the simulation comprises the MNA using the modified conductance matrix and capacitance matrix.

4. The method of claim 2, further comprising:
adding, to a netlist, compensation network information corresponding to
a plurality of nodes in the compensation network, the plurality of nodes comprising the first node,
conductance values associated with the plurality of nodes, the conductance values correspond to the resistance values of the resistors in the compensation network, and
the capacitance values of the capacitors in the compensation network,
wherein the simulation comprises using the netlist comprising the compensation network information.

5. The method of claim 2, wherein
the first node corresponds to an output of an error amplifier in a compensator circuit of the voltage regulator.

6. The method of claim 1, wherein
the voltage regulator is a multi-phase voltage regulator having a number of phases, and
said determining the model parameters comprises determining a model parameter among the model parameters based on
a corresponding parameter among the parameters of the voltage regulator, and
the number of phases of the voltage regulator.

7. The method of claim 1, wherein
the simulation comprises a simulation of the voltage regulator together with at least one of
an input network coupled to an input of the voltage regulator, or
an output network coupled to an output of the voltage regulator.

8. The method of claim 7, further comprising:
based on a duty ratio of the voltage regulator, modifying network model parameters of a network model of the input network,
wherein the simulation comprises using the modified network model parameters of the network model.

9. The method of claim 1, wherein
the simulation comprises an alternating current (AC) simulation of the voltage regulator together with at least one of
an input network coupled to an input of the voltage regulator, or
an output network coupled to an output of the voltage regulator.

10. The method of claim 1, further comprising:
based on a result of the simulation, modifying a configuration of the voltage regulator.

11. A system, comprising a processor configured to:
determine model parameters of a voltage regulator (VR) model of a voltage regulator, based on design specifications of the voltage regulator, and
perform a simulation of the voltage regulator, using the model parameters of the VR model,
wherein
the VR model comprises:
a voltage source coupled between an input of the voltage regulator and an output of the voltage regulator, and
a compensation network of capacitors and resistors, the compensation network coupled between the output and a first node, and
the model parameters of the VR model comprise:
resistance values of the resistors in the compensation network,
capacitance values of the capacitors in the compensation network, and
a voltage value of the voltage source which does not depend on an input voltage at the input of the voltage regulator.

12. The system of claim 11, wherein
the first node corresponds to an output of an error amplifier in a compensator circuit of the voltage regulator, and
the error amplifier is an operational amplifier configured to operate in a linear region.

13. The system of claim 11, wherein
the processor is configured to
based on the design specifications of the voltage regulator, determine parameters of the voltage regulator, and
based on the parameters of the voltage regulator, determine the model parameters of the VR model.

14. The system of claim 13, wherein
the voltage regulator is a multi-phase voltage regulator having a number of phases, and
the processor is configured to determine a model parameter among the model parameters, based on
a corresponding parameter among the parameters of the voltage regulator, and
the number of phases of the voltage regulator.

15. The system of claim 11, wherein
the processor is configured to perform the simulation of the voltage regulator together with at least one of
an input network coupled to an input of the voltage regulator, or
an output network coupled to an output of the voltage regulator.

16. The system of claim 15, wherein
the processor is configured to
based on a duty ratio of the voltage regulator, modify network model parameters of a network model of the input network, and
perform the simulation of the voltage regulator together with at least the input network, using the modified network model parameters of the network model.

17. The system of claim 11, wherein
the processor is further configured to
based on a result of the simulation, modify a configuration of the voltage regulator.

18. A computer program product, comprising a non-transitory, computer-readable storage medium containing therein instructions executable by a processor to cause the processor to:
determine model parameters of a voltage regulator (VR) model of a voltage regulator, based on design specifications of the voltage regulator, wherein the VR model comprises:
a compensation network of capacitors and resistors,
modify a conductance matrix of a modified nodal analysis (MNA), by adding a plurality of nodes in the compensation network and conductance values associated with the plurality of nodes to the conductance matrix, the conductance values associated with the plurality of nodes correspond to resistance values of the resistors in the compensation network,
modify a capacitance matrix of the MNA, by adding the plurality of nodes and capacitance values of the capacitors in the compensation network to the capacitance matrix, and
perform a simulation of the voltage regulator, wherein the simulation comprises the MNA using the modified conductance matrix and the modified capacitance matrix.

19. The computer program product of claim 18, wherein
the VR model further comprises:
a voltage dependent voltage source, a first resistor and a first inductor coupled in series between an input and an output of the voltage regulator, wherein the compensation network is coupled between the output and a first node, and
the model parameters of the VR model comprise:
a first inductance value of the first inductor,
a first resistance value of the first resistor,
the resistance values of the resistors in the compensation network,
the capacitance values of the capacitors in the compensation network, and
a voltage value of the voltage dependent voltage source which depends on a voltage value at the first node.

20. The computer program product of claim 19, wherein
the voltage value of the voltage dependent voltage source is independent from an input voltage at the input of the voltage regulator.
